(19) United States
(12) Patent Application Publication
(10) Pub. No.: US 2009/0215514 A1
(43) Pub. Date: Aug. 27, 2009

(54) Gaming Machine with Conversation Engine for Interactive Gaming Through Dialog with Player and Playing Method Thereof

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/359,060

(22) Filed: Jan. 23, 2009

Related U.S. Application Data
(60) Provisional application No. 61/031,242, filed on Feb. 25, 2008.

(51) Int. Cl. A63F 9/24; G06F 17/28

(52) U.S. Cl. 463/17; 704/3

(57) ABSTRACT

A gaming machine outputs, from an output unit, a message or a conversation sentence to inquire a language type to be used in a game in the forms of sounds and characters. A player inputs, into an input unit, a response message or a response sentence to designate the language type that the player wishes to use in a game. Thereafter, the gaming machine determines to use the language type designated in the response message as the language type in the game. Moreover, the gaming machine converts an amount of an award in the game from a standard currency into a currency corresponding to the designated language type, and outputs the converted amount from the output unit.

### CROSS REFERENCE TO RELATED APPLICATIONS

This application claims priority to co-pending U.S. provisional patent application Ser. No. 61/031,242 filed on Feb. 25, 2008, and which is incorporated by reference herein for all purposes.

### BACKGROUND OF THE INVENTION

1. Field of the Invention

The present invention relates to a gaming machine equipped with a conversation engine for interactive gaming through dialog with a player using voices and characters as media, and to a playing method thereof.

2. Description of Related Art

US Patent Application Publication No. 2007/0094004, US Patent Application Publication No. 2007/0094005, US Patent Application Publication No. 2007/0094007, and US Patent Application Publication No. 2007/0094008 disclose conversation controllers. The conversation controllers disclosed in these specifications are configured to recognize contents of topics of a speaker which are inputted to a microphone or the like, and to output, from the speaker or the like, response voices corresponding to the recognized contents of the topics.

Meanwhile, U.S. Pat. No. 5,820,459, U.S. Pat. No. 6,695,697, US Patent Application Publication No. 2003/0069073, European Patent Application Publication No. 1192975, U.S. Pat. No. 6,254,483, U.S. Pat. No. 5,611,730, U.S. Pat. No. 5,639,088, U.S. Pat. No. 6,257,981, U.S. Pat. No. 6,234,896, U.S. Pat. No. 6,001,016, U.S. Pat. No. 6,273,820, U.S. Pat. No. 6,224,482, U.S. Pat. No. 4,669,731, U.S. Pat. No. 6,244,957, U.S. Pat. No. 5,910,048, U.S. Pat. No. 5,695,402, U.S. Pat. No. 6,003,013, U.S. Pat. No. 4,283,709, European Patent Application Publication No. 0631798, German Patent Application Publication No. 4137010, GB No. 2326830A, German Patent Application Publication No. 3712841, U.S. Pat. No. 4,964,638, U.S. Pat. No. 6,089,980, U.S. Pat. No. 5,280,909, U.S. Pat. No. 5,702,303, U.S. Pat. No. 6,270,409, U.S. Pat. No. 5,770,533 U.S. Pat. No. 5,836,817, U.S. Pat. No. 6,932,704, U.S. Pat. No. 6,932,707, U.S. Pat. No. 4,837,728, European Patent Application Publication No. 1302914, U.S. Pat. No. 4,624,459, U.S. Pat. No. 5,564,700, International Patent Application WO 03/083795, German Patent Application Publication No. 3242890, European Patent Application Publication No. 0840264, German Patent Application Publication No. 10049444, International Patent Application WO 04/095383, European Patent Application Publication No. 1544811, U.S. Pat. No. 5,890,963, European Patent Application Publication No. 1477947, and European Patent Application Publication No. 1351180 disclose slot machines which are a type of gaming machines. The gaming machines such as the slot machines disclosed in these specifications are configured to allow players to make bets by use of coins, credits or the like in order to play games offered by those gaming machines. Accordingly, in terms of these gaming machines, it is essential to exchange information between players and the gaming machines.

### SUMMARY OF THE INVENTION

An object of the present invention is to provide a gaming machine and a playing method thereof, which are capable of offering an advanced service to a player.

A first aspect of the present invention is a gaming machine comprising: an output unit configured to output a conversation sentence to a player; an input unit configured to enable a player to input a response sentence to the conversation sentence outputted from the output unit; a conversation engine configured to create data on the conversation sentence to be outputted from the output unit and configured to analyze data on the response sentence inputted into the input unit; a currency memory configured to store currency data linking a plurality of language types usable for play on the gaming machine, with currency types respectively corresponding to the language types; a rate memory configured to store rate data indicating conversion rates of the respective currency types to a standard currency in the currency data; and a controller configured to (a) cause the conversation engine to create data on the conversation sentence inquiring a language type to be used for play on the gaming machine, (b) judge whether or not the language type to be used for play on the gaming machine is designated in the response sentence having the data analyzed by the conversation engine, and (c) upon the language type to be used for play on the gaming machine being designated in the response sentence having the data analyzed by the conversation engine, cause the conversation engine to create data on a subsequent conversation sentence including information on a converted amount of an award generated during repeatedly executed unit games, the converted amount of the award being expressed in a certain one of the currency types linked with the designated language type in the currency data and being obtained by conversion from the standard currency at the conversion rate of the certain currency type.

A second aspect of the present invention is a gaming machine comprising: an output unit configured to display a conversation sentence to a player; an input unit configured to enable a player to input a response sentence to the conversation sentence displayed on the output unit; a conversation engine configured to create data on the conversation sentence to be displayed on the output unit and configured to analyze data on the response sentence inputted into the input unit; a currency memory configured to store currency data linking a plurality of language types usable for play on the gaming machine, with currency types respectively corresponding to the language types; a rate memory configured to store rate data indicating conversion rates of the respective currency types to a standard currency in the currency data; and a controller configured to (a) cause the conversation engine to create data on the conversation sentence inquiring the language type to be used for play on the gaming machine, (b) judge whether or not the language type to be used for play on the gaming machine is designated in the response sentence having the data analyzed by the conversation engine, and (c) upon the language type to be used for play on the gaming machine being designated in the response sentence having the data analyzed by the conversation engine, cause the conversation engine to create data on a subsequent conversation sentence including information on a converted amount of an award generated during repeatedly executed unit games, the converted amount of the award being expressed in a certain one of the currency types linked with the designated language type in the currency data and being obtained by conversion from the standard currency at the conversion rate of the certain currency type.

A third aspect of the present invention is a gaming machine comprising: an output unit configured to output a conversation sentence to a player; an input unit configured to enable a player to input a response sentence to the conversation sentence outputted from the output unit; a conversation engine configured to create data on the conversation sentence to be outputted from the output unit and configured to analyze data on the response sentence inputted into the input unit; a display configured to display repeatedly executed unit games together with an amount of an award in a standard currency generated in the unit games; a currency memory configured to store currency data linking each of a plurality of language types usable for play on the gaming machine, with at least one currency type corresponding to the language type; a rate memory configured to store rate data indicating conversion rates of the respective currency types to the standard currency in the currency data; and a controller configured to (a) cause the conversation engine to create data on the conversation sentence inquiring the language type to be used for play on the gaming machine, (b) judge whether or not the language type to be used for play on the gaming machine is designated in the response sentence having the data analyzed by the conversation engine, (c) upon the language type to be used for play on the gaming machine being designated in the response sentence having the data analyzed by the conversation engine, judge whether or not there are a plurality of currency types linked with the designated language type in the currency data, (d) upon there being the plurality of currency types linked with the designated language type in the currency data, cause the conversation engine to create data on a conversation sentence inquiring selection of the currency type to be used for display of the award on the display, out of the plurality of currency types linked with the designated language type in the currency data, (e) judge whether or not the currency type to be used for display of the award on the display is designated in a response sentence having the data analyzed by the conversion engine, and (f) upon the currency type to be used for display of the award on the display being designated in the response sentence having the data analyzed by the conversion engine, display a converted amount of the award, the converted amount being obtained by conversion from the standard currency at the conversion rate of the designated currency type.

A fourth aspect of the present invention is a method of playing a gaming machine comprising: (a) causing a conversation engine to create data on a conversation sentence inquiring of a player what language type to be used for play on the gaming machine, (b) outputting the conversation sentence inquiring what language type to be used for play on the gaming machine by using the data created by the conversation engine; (c) enabling the player to input, into an input unit, a response sentence designating the language type to be used for play on the gaming machine; (d) causing the conversation engine to analyze data on the response sentence inputted into the input unit by the player; (e) judging whether or not the language type to be used for play on the gaming machine is designated in the response sentence having the data analyzed by the conversation engine; (f) upon the language type to be used for play on the gaming machine being designated in the response sentence having the data analyzed by the conversation engine, specifying a currency type linked with the designated language type in currency data stored in a currency memory, the currency data linking a plurality of language types usable for play on the gaming machine, with currency types respectively corresponding to the language types; (g) converting an amount of an award generated in repeatedly executed unit games from a standard currency into the specified currency type by using one of the conversion rates of the respective currency types to the standard currency in the currency data, the conversion rates being indicated by rate data stored in a rate memory; (h) causing the conversation engine to create data on a conversation sentence including information on the converted amount of the award in the specified currency type; and (i) outputting, from the output unit, the conversation sentence including the information on the converted amount of the award in the specified currency type by using the data created by the conversation engine every time of generation of the award.

A fifth aspect of the present invention is a method of playing a gaming machine comprising: (a) causing a conversation engine to create data on a conversation sentence inquiring of a player what language type to be used for play on the gaming machine, (b) outputting the conversation sentence inquiring what language type to be used for play on the gaming machine by using the data created by the conversation engine; (c) enabling the player to input, into an input unit, a response sentence designating the language type to be used for play on the gaming machine; (d) causing the conversation engine to analyze data on the response sentence inputted into the input unit by the player; (e) judging whether or not the language type to be used for play on the gaming machine is designated in the response sentence having the data analyzed by the conversation engine; (f) upon the language type to be used for play on the gaming machine being designated in the response sentence having the data analyzed by the conversation engine, judging whether or not there are a plurality of currency types linked with the designated language type in currency data stored in a currency memory, the currency data linking each of a plurality of language types usable for play on the gaming machine, with at least one currency type corresponding to the language type; (g) upon there being the plurality of currency types linked with the designated language type in the currency data, causing the conversation engine to create data on a conversation sentence inquiring selection of the currency type to be used for display of the award on the display out of the plurality of currency types linked with the designated language type in the currency data; (h) judging whether or not the currency type to be used for display of the award on the display is designated in a response sentence having the data analyzed by the conversion engine; and (i) upon the currency type to be used for display of the award on the display being designated in the response sentence having the data analyzed by the conversion engine, displaying a converted amount of an award in the designated currency type on the display, the converted amount of the award being obtained by conversion from the standard currency at a conversion rate of the designated currency type to the standard currency indicated by rate data stored in a rate memory.

### BRIEF DESCRIPTION OF THE DRAWINGS

FIG. 1 is a schematic flow chart showing a playing method of a gaming machine according to an embodiment of the present invention.

FIG. 2 is a diagram showing a perspective view of a gaming terminal according to an embodiment of the present invention.

FIG. 3 is a diagram showing a perspective view of an outward appearance of a schematic configuration of a roulette game machine according to an embodiment of the present embodiment.

FIG. 4 is a diagram showing a plan view of a roulette device according to an embodiment of the present embodiment.

FIG. 5 is a diagram showing one example of an image to be displayed on a display of the gaming terminal shown in FIG. 2.

FIG. 6 is a block diagram showing an internal configuration of a roulette game machine according to an embodiment of the present embodiment.

FIG. 7 is a block diagram showing an internal configuration of a roulette device according to an embodiment of the present embodiment.

FIG. 8 is a block diagram showing an internal configuration of a gaming terminal according to an embodiment of the present embodiment.

FIG. 9 is a block diagram of a conversation controller available as a conversation engine installed in a gaming terminal according to an embodiment of the present invention.

FIG. 10 is a block diagram of a speech recognition unit according to an embodiment of the present invention.

FIG. 11 is a timing chart of a process of a word hypothesis refinement unit according to an embodiment of the present invention.

FIG. 12 is a flow chart of an operation of the speech recognition unit according to an embodiment of the present invention.

FIG. 13 is a partly enlarged block diagram of the conversation controller according to an embodiment of the present invention.

FIG. 14 is a diagram illustrating a relation between a character string and morphemes extracted from the character string according to an embodiment of the present invention.

FIG. 15 is a diagram illustrating types of uttered sentences, plural two letters in the alphabet which represent the types of the uttered sentences, and examples of the uttered sentences according to an embodiment of the present invention.

FIG. 16 is a diagram illustrating details of dictionaries stored in an utterance type database according to an embodiment of the present invention.

FIG. 17 is a diagram illustrating details of a hierarchical structure built in a conversation database according to an embodiment of the present invention.

FIG. 18 is a diagram illustrating a refinement of topic identification information in the hierarchical structure built in the conversation database according to an embodiment of the present invention.

FIG. 19 is a diagram illustrating contents of topic titles formed in the conversation database according to an embodiment of the present invention.

FIG. 20 is a diagram illustrating types of reply sentences associated with the topic titles formed in the conversation database according to an embodiment of the present invention.

FIG. 21 is a diagram illustrating contents of the topic titles, the reply sentences and next plan designation information associated with the topic identification information according to an embodiment of the present invention.

FIG. 22 is a diagram illustrating a plan space according to an embodiment of the present invention.

FIG. 23 is a diagram illustrating one example a plan transition according to an embodiment of the present invention.

FIG. 24 is a diagram illustrating another example of the plan transition according to an embodiment of the present invention.

FIG. 25 is a diagram illustrating details of a plan conversation control process according to an embodiment of the present invention.

FIG. 26 is a flow chart of a main process in a conversation control unit according to an embodiment of the present invention.

FIG. 27 is a flow chart of a part of a plan conversation control process according to an embodiment of the present invention.

FIG. 28 is a flow chart of the rest of the plan conversation control process according to an embodiment of the present invention.

FIG. 29 is a transition diagram of a basic control state according to an embodiment of the present invention.

FIG. 30 is a flow chart of a discourse space conversation control process according to an embodiment of the present invention.

FIG. 31 is a flow chart showing gaming processings of a server and a roulette device of a roulette game machine according to an embodiment of the present embodiment.

FIG. 32 is a flow chart showing gaming processings of the server and the roulette device of the roulette game machine according to an embodiment of the present embodiment.

FIG. 33 is a flow chart showing gaming processings of a gaming terminal of the roulette game machine according to an embodiment of the present embodiment.

FIG. 34 is a flow chart showing a used language confirmation processing shown in FIG. 33.

FIG. 35 is a flow chart showing a betting period confirmation processing shown in FIG. 33.

FIG. 36 is a flow chart showing a bet accepting processing shown in FIG. 33.

FIG. 37 is a flow chart showing a payout amount output processing shown in FIG. 33.

FIG. 38 is a diagram showing one example of currency data.

FIG. 39 is a diagram showing one example of rate data.

FIG. 40 is a diagram showing one example of an image to be displayed on the display.

FIG. 41 is a diagram showing one example of an image to be displayed on the display.

FIG. 42 is a diagram showing one example of an image to be displayed on the display.

FIG. 43 is a flow chart showing a used language confirmation processing shown in FIG. 33.

FIG. 44 is a diagram showing one example of an image to be displayed on the display.

### DETAILED DESCRIPTION OF THE EMBODIMENT

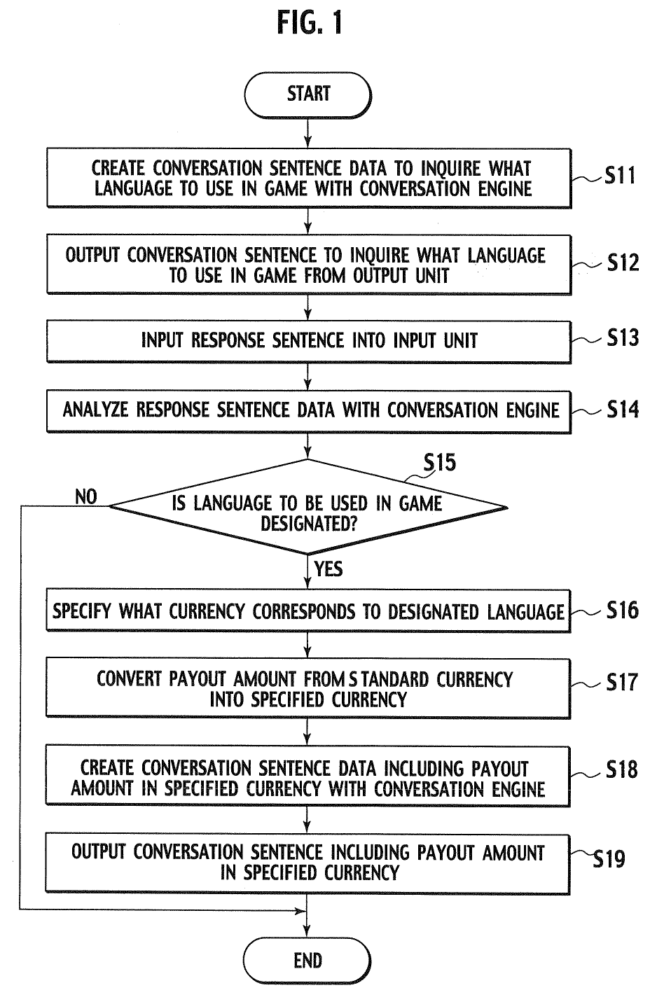

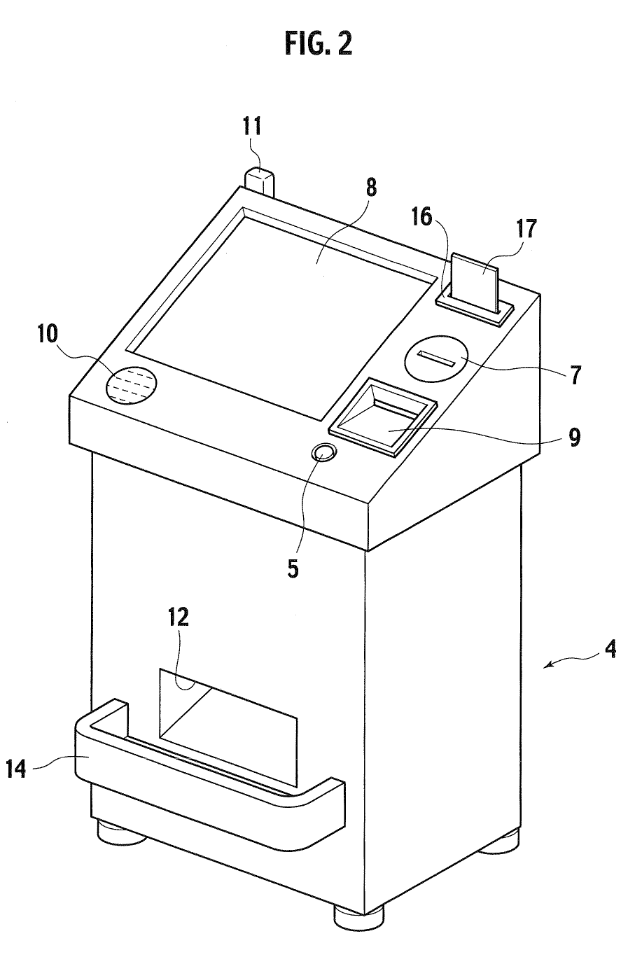

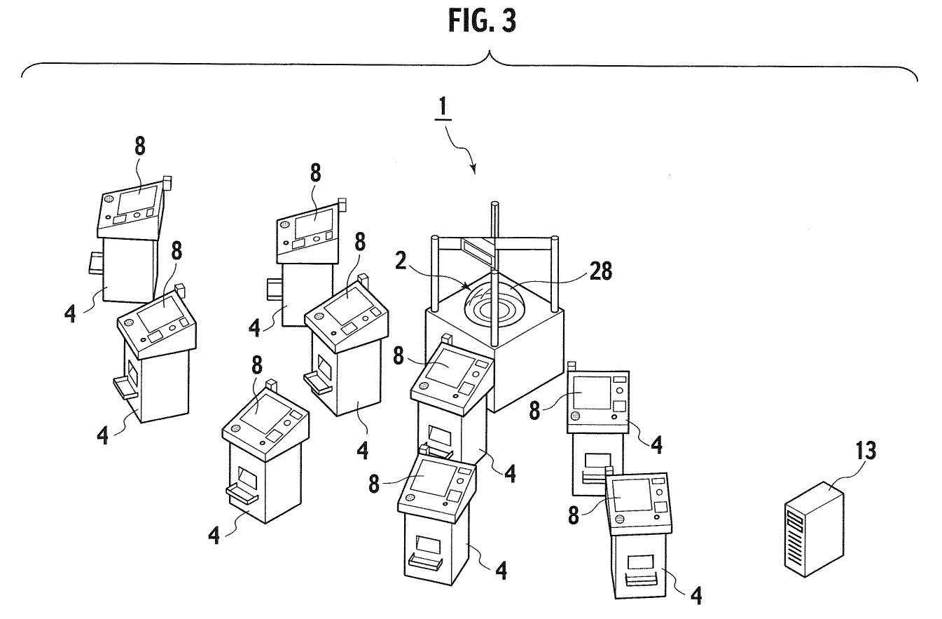

Now, operations of a gaming terminal representing an example of a gaming machine according to the present invention and outlines of a playing method thereof will be described below with reference to a flow chart shown in FIG. 1, a perspective view of a gaming machine shown in FIG. 2, and an outward perspective view of a roulette game machine shown in FIG. 3.

First, in a gaming terminal 4 according to an embodiment of the present invention shown in FIG. 2, a player can participate in a roulette game executed in a roulette device 2 by betting credits through a BET screen displayed on a display 8.

Then, data of a conversation sentence to inquire to the player what language type to use for playing a roulette game are created by use of a conversation engine of the gaming terminal 4 shown in FIG. 2 (step S11). Next, the conversation sentence to inquire what language type to use for playing the roulette game is outputted from an output unit of the gaming terminal 4 by using the data created by the conversation engine (step S12).

Subsequently, the player inputs, into an input unit of the gaming terminal 4, a response sentence to designate the language type to be used for playing the roulette game in response to the conversation sentence outputted from the output unit (step S13). Then, data on the response sentence inputted into the input unit by the player are analyzed with the conversation engine of the gaming terminal 4 (step S14).

Next, a judgment is made as to whether or not the language type to be used for playing the roulette game is designated in the conversation sentence analyzed by the conversation engine of the gaming terminal 4 (step S15). Then, when the language type to be used for playing the roulette game is designated (YES in step S15), a currency type corresponding to the designated language type is specified (step S16).

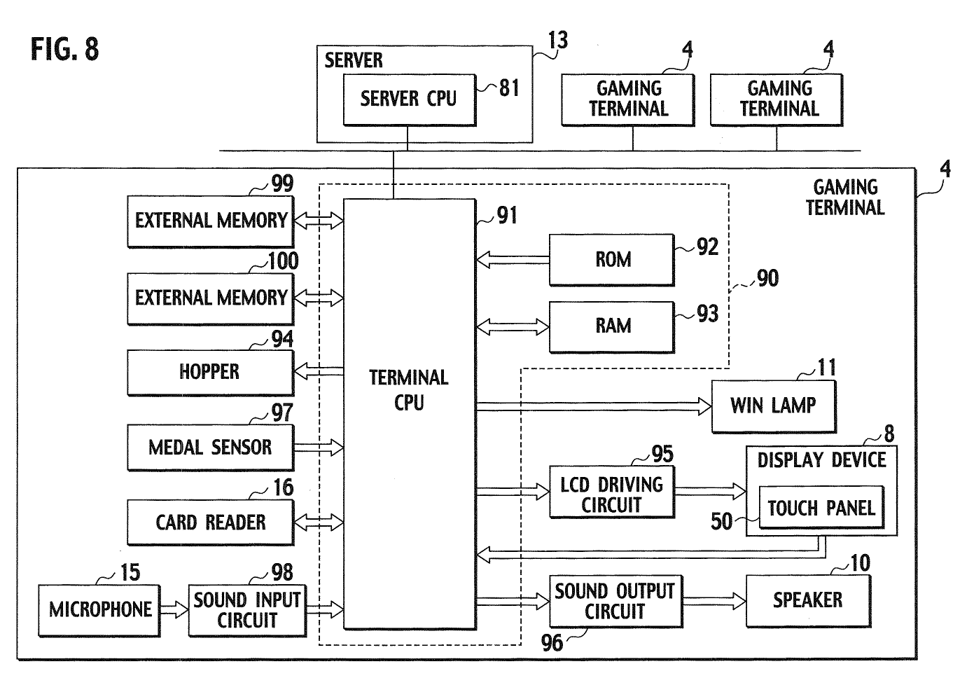

Here, the currency type corresponding to the designated language type can be specified by currency data that link the multiple language types that can be used for playing the roulette game with the currency types respectively corresponding to the language types, which are stored in an external memory 99 (see FIG. 8) of the gaming terminal 4.

Further, a payout (award) amount in standard currency in the roulette games repeatedly executed in the gaming terminal 4 is converted into an amount in the currency type (the specified currency type) corresponding to the designated language type which is specified in step S16 (step S17).

Here, the payout amount in standard currency can be converted into the amount in the currency type (the specified currency type) corresponding to the designated language type using rate data indicating conversion rates between the base currency and the respective currency types in currency data stored in the external memory 99 (see FIG. 8).

Then, data on a conversation sentence including the converted payout in the specified currency type are created by the conversion engine of the gaming terminal 4 (step S18). As a result, when the language type to be used for playing the roulette game is designated, the sentence including the converted payout amount in the specified currency type is outputted from the output unit of the gaming terminal 4 by use of the data created by the conversion engine each time of the payout in the roulette game (step S19).

According to the gaming terminal 4 and the playing method thereof according to the embodiment of the present invention, when the player inputs, into the input unit, the response sentence to designate the language type to be used for playing the roulette game with the gaming terminal 4 in response to the conversation sentence to be outputted from the output unit of the gaming terminal 4, the payout amount in each roulette game is outputted from the output unit of the gaming terminal 4 without converted into the default standard currency but into the currency type corresponding to the language type to be used for the roulette game which is designated by the player. As a result, the payout amount in currency to be outputted from the output unit is changed so as to correspond to the language type designated in the course of interactive communication between the gaming terminal 4 and the player. Hence it is possible to achieve interactive gaming.

Next, a gaming terminal according to the embodiment of the present invention will be described together with a roulette device including the gaming terminal with reference to FIG. 2 to FIG. 44.

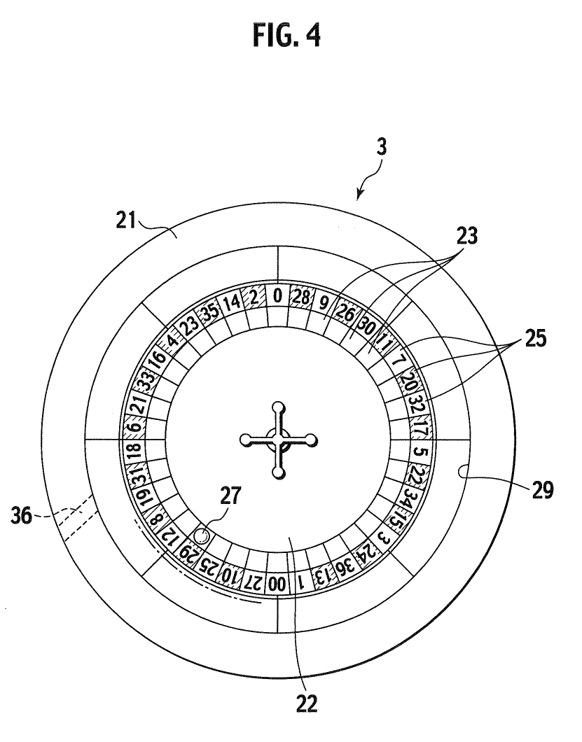

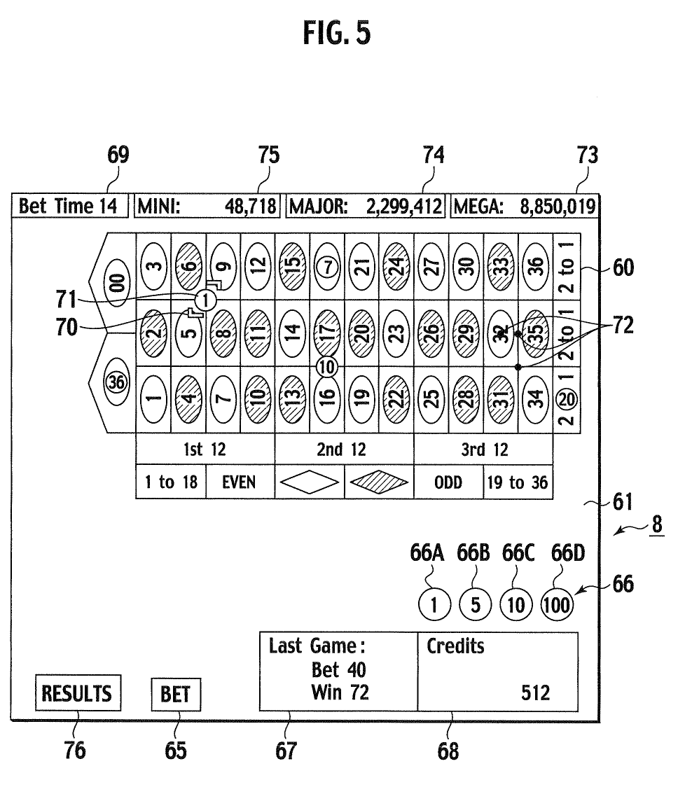

FIG. 2 is a diagram showing a perspective view of the gaming terminal according to the embodiment of the present invention. FIG. 3 is a diagram showing a perspective view of an outward appearance of a schematic configuration of a roulette game machine including the gaming terminal shown in FIG. 2 according to the embodiment of the present invention. FIG. 4 is a diagram showing a plan view of a roulette device 2 provided in the roulette game machine shown in FIG. 3. FIG. 5 is a diagram showing one example of an image to be displayed on a display of the gaming terminal shown in FIG. 2.

Multiple gaming terminals 4 (gaming machines) according to the embodiment of the present invention shown in FIG. 2 are provided in a roulette game machine 1 shown in FIG. 3. In addition thereto, the roulette game machine 1 includes a roulette device 2 and a server 13. The respective gaming terminals 4, the roulette device 2, and the server 13 can be connected to one another by use of a local area network, for example.

At the roulette device 2, the roulette game will be executed under the control of the server 13, and the game will be displayed to the players. The players use a plurality of gaming terminals 4 that are arranged around the roulette device 2, in order to participate in the roulette game displayed by the roulette device 2. In the present embodiment, the roulette game machine 1 has nine gaming terminals 4. Consequently, at most nine players can participate in the communal roulette game simultaneously.

The roulette games to be displayed on the roulette device 2 are repeatedly executed at a cycle of a predetermined time period under control by the server 13. Accordingly, each of the players can make bets on a current roulette game by use of one of the gaming terminals 4. To make bets on the current roulette game, each of the gaming terminals 4 is provided with a display 8. A BET screen 61 (see FIG. 5) corresponding to the roulette game is displayed on this display 8. Display contents of this BET screen 61 will be described later in detail.

FIG. 4 is a plan view of a roulette device provided in a roulette game machine of FIG. 3.

As shown in FIG. 4, the roulette device 2 has a frame 21, and a roulette wheel 22 which is accommodated and supported rotatably inside the frame 21. On an upper surface of the roulette wheel 22, a plurality (38 in total in the present embodiment) of number pockets 23 is formed. In addition, on an upper surface of the roulette wheel 22 on an outer side of the number pockets 23, number plates 25 are provided for displaying numbers “0”, “00”, “1” to “36” in correspondence to the respective number pockets 23.

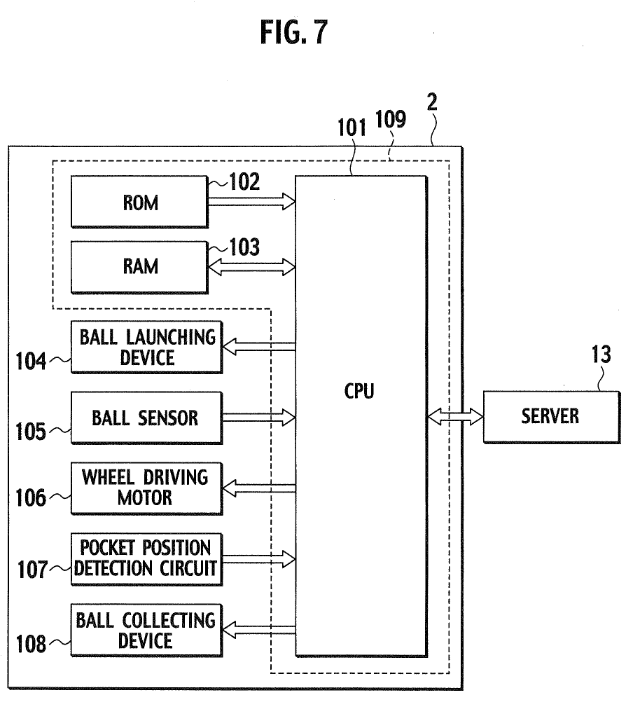

A ball launching hole 36 is opened on the inner periphery of the frame 21. The ball launching hole 36 is connected to a ball launching device 104 (see FIG. 7). In conjunction with the activation of the ball launching device 104, a ball 27 will be entered onto the roulette wheel 22 from the ball launching hole 36. Also, a hemispherical transparent acrylic cover 28 covers over the roulette device 2 (see FIG. 3).

A wheel driving motor 106 (see FIG. 7) is provided on a lower side of the roulette wheel 22. In conjunction with the activation of the wheel driving motor 106, the roulette wheel 22 will be rotated. Metal plates (not shown) are attached at prescribed intervals on a lower surface of the roulette wheel 22. As a proximity sensor of a pocket position detection circuit 107 (see FIG. 7) detects these metal plates, a position of the number pocket 23 is detected.

The frame 21 is gently inclined toward an inner side, and a guide wall 29 is formed on its middle section. The entered ball 27 is rolled by being guided by the guide wall 29 due to its centrifugal force. The ball 27 rolls down the slope of the frame 21 toward the inner side as the rotational speed decreases and the centrifugal force becomes weaker, and reaches to the rotating roulette wheel 22. Then, the ball 27 that reached to the roulette wheel 22 further falls into one of the number pockets 23 by passing over the number plates 25 on an outer side of the rotating roulette wheel 22. As a result, the number on the number plate 25 of the number pocket 23 into which the ball fell is judged by a ball sensor 105, and this number will become a winning number.

Next, the configuration of the gaming terminal 4 will be described.

As shown in FIG. 2, the gaming terminal 4 has a medal insertion slot 7 for inserting game media (currency value: such as cash, a chip, a medal, etc.) and a above-mentioned display 8 for displaying images related to the game on its upper face. The gaming terminal 4 accepts the betting operation by the player by using the medal insertion slot 7 and the display 8. The player can play the game by operating the touch panel 50 (see FIG. 7) or the like that is provided on a front face of the display 8 while watching the images displayed on the display 8. Note that, in the following description, the game media may be referred as their representative “medals”.

Also, besides the medal insertion slot 7 and the display 8 described above, a payout button 5, a ticket printer 6, a bill insertion slot 9, a speaker 10, a microphone 15, and a card reader 16 are provided on an upper face of the gaming terminal 4. A medal payout opening 12 and a medal tray 14 are provided in a front face of the gaming terminal 4.

The payout button 5 is a button for inputting a command for paying out credited medals from the medal payout opening 12 to the medal tray 14. The ticket printer 6 prints out as the bar code ticket including the data such as the credits, the date, and the identification number of the gaming terminal 4. The player can use the bar code ticket at another gaming terminal 4 and the player can bet to the game at that gaming terminal 4. Or the player can exchange the bar code ticket to bills or the like at a prescribed location (a cashier in the casino, for example) in the gaming facility.

The bill insertion slot 9 is configured to validate the appropriateness of bills and to accept authentic bills. Here, the bill insertion slot 9 may also be configured to be capable of reading a bar-coded ticket 39. The speaker 10 is used to output music, sound effects, speech messages (conversation sentences) to the player, and the like. The microphone 15 is used to input a speech message (a response sentence) uttered by the player.

The card reader 16, in which a smart card 17 (a portable memory) can be inserted, reads data out of the inserted smart card 17 and writes data into the smart card 17. The smart card, owned by the player, includes member card unique to the player, a credit card.

The data concerning the gaming history executed by the player (game history information) are stored in the smart card 17 together with data for identifying the player. The gaming history information includes game type information concerning games ever played by the player, points awarded in the games played in the past, and a language type used by the player in the course of the games. The smart card 17 may further store data corresponding to coins, bills or credits. Concerning a method of writing and reading the data in and out of this smart card 17, any of a contact method and a non-contact method (a radio-frequency identification or RFID method) is applicable. Alternatively, a magnetic stripe card is also applicable, instead of the smart card 17.

On an upper side of the display 8 of each gaming terminal 4, a WIN lamp 11 is provided respectively. In the case where the number (“0”, “00” and “1” to “36” in the present embodiment) bet at the gaming terminal 4 in the game becomes the winning number, the WIN lamp 11 of the winning gaming terminal 4 will be turned on. Also, in the jackpot (referred hereafter also as JP) bonus game for obtaining JP, the WIN lamp 11 of the gaming terminal 4 that obtained JP will be turned on similarly. Note that this WIN lamp 11 provided at a position that is visible from all of the arranged gaming terminals 4 (9 sets in the present embodiment), such that the other players who are playing at the same roulette game machine 1 can always check which WIN lamp 11 is turned on.

Inside the medal insertion slot 7, a medal sensor (not shown) is provided, and it identifies the currency values such as medals that are inserted at the medal insertion slot 7, and counts the inserted medals. Also, a hopper (not shown) is provided inside the medal payout opening 12 and it pays a prescribed number of medals from the medal payout opening 12.

FIG. 5 is the diagram showing one example of an image to be displayed on the display.

The BET screen 61 as shown in FIG. 5 is displayed on the display 8 of each of the gaming terminals 4. The BET screen 61 includes a table-type betting board 60. The player can make bets on a roulette game by using his or her chips credited in the gaming terminal 4 in the form of electronic information and by operating a touch panel 50 (see FIG. 7) provided on a front face of the display 8.

To be more precise, the player indicates with a cursor 70 a BET area 72 (on a number and a grid of a mark of the number or on a line forming the grid) which is a target for making bets of chips. Then, the player indicates with unit BET buttons 66 the number of chips to be bet and confirms the number of bet chips with a BET confirmation button 65. The above described operations can be executed with the player directly pressing, with fingers, the sections where the BET area 72, the unit BET buttons 66, and the BET confirmation button 65 are displayed on the display 8.

Here, four types of the unit BET buttons 66, namely, a 1 BET button 66A, a 5 BET button 66B, a 10 BET button 66C, and a 100 BET button 66D are provided corresponding to the number of chips that can be bet in one operation.

The number of chips bet in the previous game by the player and the number of payout credits are displayed on a payout result display unit 67 of the display 8. Meanwhile, the number of credits currently owned by the player is displayed on a credit number display unit 68 of the display 8. Moreover, remaining time for which the player can make bets is displayed on a BET time display unit 69 of the display 8.

Note that when the ball 27 entered on the roulette wheel 22 is housed in any of the number pockets 23, the winning number is confirmed and the current roulette game is finished, the next roulette game is started.

A MEGA counter 73 displaying the number of credits accumulated for a “MEGA” JP, a MAJOR counter 74 displaying the number of credits accumulated for a “MAJOR” JP, and a MINI counter 75 displaying the number of credits accumulated for a “MINI” JP are provided at the right side of the bet time display unit 69. In the case where any one of the JPs is won in the JP bonus game, a JP payout is provided according to the winning credits of the one of the JPs displayed on the respective counters 73 to 75. An initial value (200 credits for “MINI,” 5000 credits for “Major” and 50000 credits for “MEGA”) is displayed on the one of the counters 73 to 75 after the JP payout.

A history display button 76 is displayed on the left side of the BET confirmation button 65 on the BET screen 61. The player can display, onto the display 8, the history information on the past roulette game of the gaming terminal 4 and the past gaming history information on the player by touching the history display button 76 by means of operating the touch panel 50.

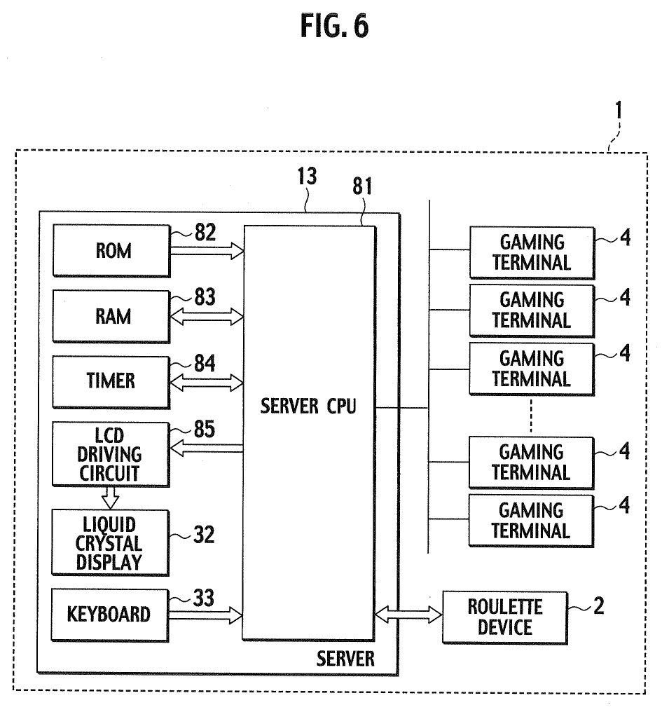

FIG. 6 is a block diagram showing an internal configuration of the roulette game machine according to the present embodiment.

As shown in FIG. 6, the roulette game machine 1 has the server 13, the roulette device 2 and a plurality (9 sets in the present embodiment) of the gaming terminals 4. The roulette device 2 and the gaming terminals 4 are connected to the server 13. Note that an internal configuration of the roulette device 2 and an internal configuration of the gaming terminal 4 will be described below in detail.

The server 13 has a server CPU 81 for executing the overall control of the server 13, a ROM 82, a RAM 83, a timer 84, a LCD (Liquid Crystal Display) 32 connected through a LCD driving circuit 85, and a keyboard 33.

The server CPU 81 carries out various processings according to input signals supplied from each gaming terminals 4, and data & programs stored in the ROM 82 & the RAM 83. Also, the server CPU 81 transmits command signals to the gaming terminals 4 according to the processing results, to control each gaming terminal 4 by its initiative. Also, the server CPU 81 transmits control signals to the roulette device 2, to control the shooting of the ball 27 and the rotation of the roulette wheel 22.

The ROM 82 is formed by a semiconductor memory or the like and stores programs that implement basic functions of the roulette game machine 1, programs that execute the notification of the maintenance time and the setting & management of the notification condition, the payout rate data for the roulette game (the payout credits with respect to the win per one chip), programs for controlling each gaming terminal 4 initiatively, etc.

On the other hand, the RAM 83 temporarily stores the betting information supplied from each gaming terminal 4, the winning number of the roulette device 2 detected by the sensors, the accumulated JP credits, the data regarding the result of the processing executed by the server CPU 81, etc.

In addition, the timer 84 is connected to the server CPU 81. The time information of the timer 84 is transmitted to the server CPU 81. The server CPU 81 executes the control of the rotation of the roulette wheel 22 and the shooting of the ball 27 based on the time information of the timer 84.

FIG. 7 is a block diagram showing an internal configuration of the roulette device according to the present embodiment.

As shown in FIG. 7, the roulette device 2 has a controller 109, the pocket position detection circuit 107, the ball launching device 104, the ball sensor 105, the wheel driving motor 106, and a ball collecting device 108. The controller 109 corresponds to the controller of the present invention.

The controller 109 has a CPU 101, a ROM 102, and a RAM 103. The CPU 101 controls the shooting of the ball 27 and the rotation of the roulette wheel 22 according to the control signals supplied from the server 13, and data & programs stored in the ROM 102 & the RAM 103.

The pocket position detection circuit 107 has a proximity sensor. It detects the rotation position of the roulette wheel 22 by detecting metal plates attached to the roulette wheel 22.

The ball launching device 104 is for launching the ball 27 onto the roulette wheel 22 from the ball launching hole 36 (see FIG. 4). The ball launching device 104 shoots the ball 27 at an initial speed and at a timing set in the control data.

The ball sensor 105 is a device for detecting the number pocket 23 into which the ball 27 fell. The wheel driving motor 106 is for rotating the roulette wheel 22. The wheel driving motor 106 stops the activation after the motor driving time that is set in the control data has elapsed since the start of the activation. The ball collecting device 108 is for collecting the ball 27 on the roulette wheel 22 after the game is over.

FIG. 8 is a block diagram showing an internal configuration of the gaming terminal according to the present embodiment. Note that 9 sets of the gaming terminals 4 have basically the same configuration, and an example of one gaming terminal 4 will be described in the following.

As shown in FIG. 8, the gaming terminal 4 has a terminal controller 90 formed by a terminal CPU 91, a ROM 92 and a RAM 93. The ROM 92 is formed by a semiconductor memory or the like and stores programs that implement basic functions of the gaming terminal 4, and various programs, data table, etc., that are necessary for controlling the gaming terminal 4. Also, the RAM 93 is a memory for temporarily storing various data calculated by the terminal CPU 91, the owned credits by the player (deposited at the gaming terminal 4), the state of betting by the player, a flag F for indicating that it is under the betting period or not, etc.

To the terminal CPU 91, a payout button 5 is connected. The payout button 5 is a button to be pressed by the player usually when the game is over. When the payout button 5 is pressed by the player, the medals according to the credits acquired in the game by the player will be paid from the medal payout opening 12 (usually one medal for one credit).

The terminal CPU 91 executes various corresponding operations according to the operation signals outputted by the payout button 5 as a result of pressing of the payout button 5. More specifically, the terminal CPU 91 executes various processings when signals associated with the pressing of the bet confirmation button 65 is inputted, according to the input signals and data & programs stored in the ROM 92 & the RAM 93. The terminal CPU 91 transmits their processing results to the server CPU 81.

Also, the terminal CPU 91 receives command signals from the sever CPU 81 and controls peripheral devices constituting the gaming terminal 4, so as to proceed with the game. Also, the terminal CPU 91 executes various processings according to the above described input signals and data & programs stored in the ROM 92 & the RAM 93, depending on the processing contents. The terminal CPU 91 controls the peripheral devices constituting the gaming terminal 4 according to the processing results, so as to proceed with the game.

Also, a hopper 94 is connected to the terminal CPU 91. The hopper 94 pays a prescribed number of medals from the medal payout opening 12 (see FIG. 2) according to a command signal from the terminal CPU 91.

In addition, the display 8 is connected to the terminal CPU 91 through a LCD driving circuit 95. The LCD driving circuit 95 has a program ROM, an image ROM, an image control CPU, a work RAM, VDP (Video Display Processor), and a video RAM. The program ROM stores an image controlling program and various selection tables regarding the display at the display 8. The image ROM stores dot data for forming an image to be displayed at the display 8, for example. The image control CPU makes the determination of an image to be displayed at the display 8 from the dot data in the image ROM, according to the image control program in the program ROM, based on parameters set up by the terminal CPU 91. The work RAM is provided as a temporary memory device at a time of executing the image control program at the image control CPU. The VDP forms a display image determined by the image control CPU and outputs it to the display 8. Note that the video RAM is provided as a temporary memory device at a time of forming an image by the VDP.

Also, the touch panel 50 is attached on the front surface of the display 8. The operation information of the touch panel 50 is transmitted to the terminal CPU 91. At the touch panel 50, the betting operation by the player is carried out on the bet screen 61. More specifically, the operation of the touch panel 50 is carried out for the selection of the bet area 72 and the input via the bet buttons 66 and the bet confirmation button 65, etc. When the touch panel 50 is operated, its operation information is transmitted to the terminal CPU 91. Then, according to that information, the betting information (the bet area and the number of bets specified on the bet screen 61) is stored into the RAM 93. In addition, this betting information is transmitted to the server CPU 81, and stored in the betting information memory area of the RAM 83.

Moreover, a round output circuit 96 and the speaker 10 are connected to the terminal CPU 91. The speaker 10 generates, based on output signals from the sound output circuit 96, various sound effects for executing various effects and dialog message sounds to the player for interactive gaming.

Meanwhile, a sound input circuit 98 and the microphone 15 are connected to the terminal CPU 91. The microphone 15 is used to input through the sound input circuit 98, into the terminal CPU 91, response message sounds in the player's voice to the dialog message sounds outputted from the speaker 10.

Also, a medal sensor 97 is connected to the terminal CPU 91. The medal sensor 97 detects medals inserted from the medal insertion slot 7 (see FIG. 2). At the same time, the medal sensor 97 counts the inserted medals, and transmits its result to the terminal CPU 91. The terminal CPU 91 increases the amount of credits of the player that is stored in the RAM 93 according to the transmitted signal.

Also, a WIN lamp 11 is connected to the terminal CPU 91. The terminal CPU 91 turns on the WIN lamp 11 in a prescribed color, when the bet on the bet screen 61 won or when the JP is won.

Meanwhile, external memories 99 and 100 are connected to the terminal CPU 91. The external memories 99 and 100 are formed of hard disk devices. The terminal CPU 91 writes and reads the data in and out of the external memories 99 and 100 when appropriate.

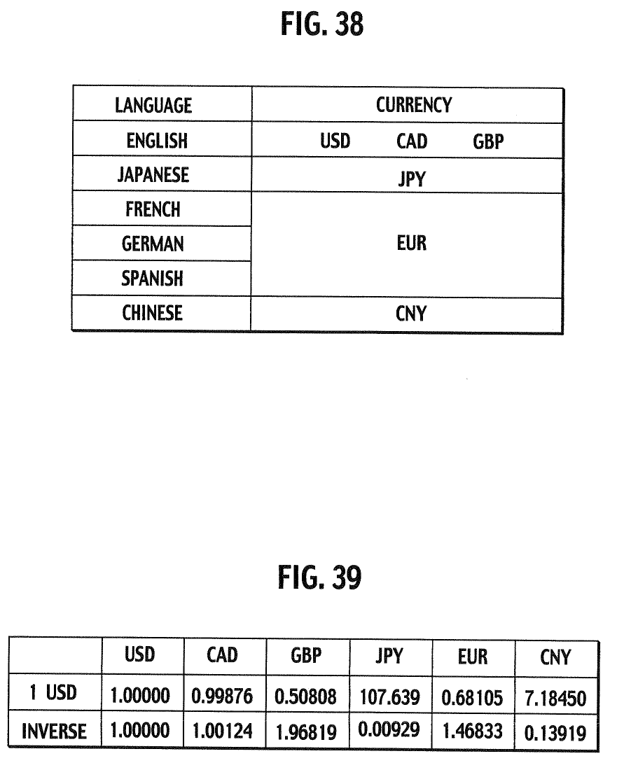

The external memory 99 (the currency memory and the rate memory) stores the currency data and the rate data. Of these data, the currency data are configured to link the multiple language types usable in the game with the currency types respectively corresponding to the language types. The currency data can be formed into a table shown in FIG. 38, for example. In this currency data example, when the language types usable in the game include English, Japanese, French, German, Spanish, and Chinese, US dollars, Canadian dollars and pounds are linked as the currencies corresponding to English. Likewise, Japanese yen is linked as the currency corresponding to Japanese while euro is liked as the currency corresponding to French, German and Spanish, respectively, and Chinese Yuan is linked as the currency corresponding to Chinese.

Meanwhile, the rate data show conversion rates of the currencies allocated to the respective language types in the currency data (which include US dollars, Canadian dollars, pounds, Japanese yen, Euro, and Chinese Yuan in the currency data shown in FIG. 38) relative to the standard currency. The rate data can be formed into a table shown in FIG. 39, for example, which applies US dollars as the standard currency and shows conversion rates of other currencies, namely, Canadian dollars, pounds, Japanese yen, Euro, and Chinese Yuan relative to the standard currency.

In the meantime, data on history information concerning outcomes and payouts of the roulette games executed by using this gaming terminal 4 in the past are stored in the external memory 100.

Moreover, the gaming terminal 4 provided with the above-described terminal controller 90 includes a conversation engine. By using this conversation engine, at least part of the roulette games on the gaming terminal 4 are interactively executed in a dialog style with the player by using the display 8, the speaker 10, and the microphone 15 as interfaces. Accordingly, in a certain scene, as the roulette game proceeds, the message sound is outputted from the speaker 10 to the player through the sound output circuit 96 and the contents of the message sounds of the player inputted through the microphone 15 and the sound input circuit 98 are analyzed.

Such a conversation engine can be achieved by using any of the conversation controllers disclosed in US Patent Application Publication No. 2007/0094007, US Patent Application Publication No. 2007/0094008, US Patent Application Publication No. 2007/0094005, and US Patent Application Publication No. 2007/0094004, for example. As will be described later, such a conversation controller can be achieved by use of the display 8 and the speaker 10, the microphone 15, the terminal controller 90, and the external memory 99 of the gaming terminal 4.

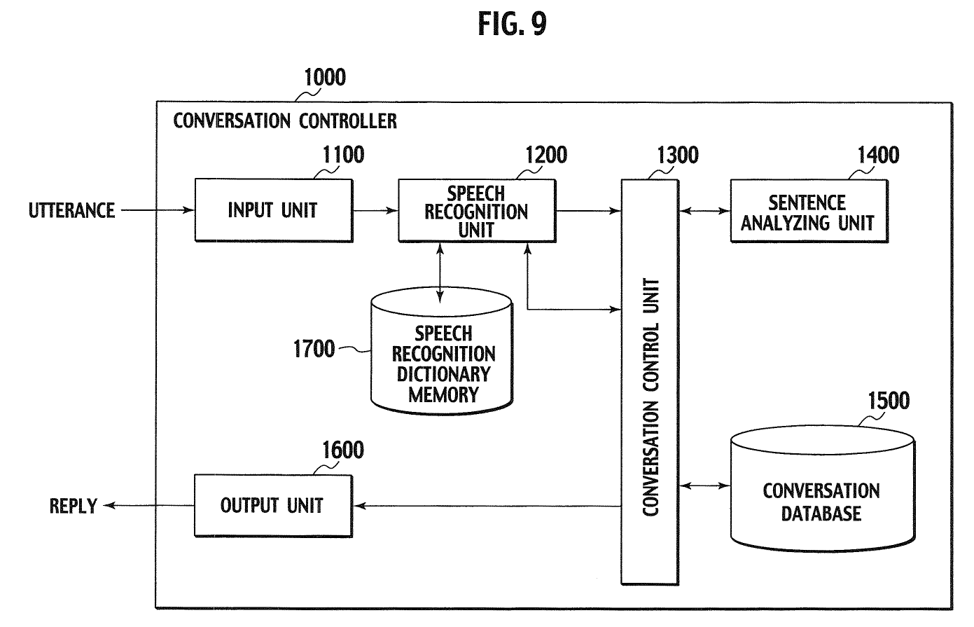

Here, a configuration of the conversation controller disclosed in US Patent Application Publication No. 2007/0094007, which is available as the conversation engine to be installed on the gaming terminal 4 of this embodiment, will be described with reference to FIG. 9 to FIG. 30. FIG. 9 is a functional block diagram showing a configuration example of a conversation controller.

As shown in FIG. 9, a conversation controller 1000 includes an input unit 1100, a speech recognition unit 1200, a conversation control unit 1300, a sentence analyzing unit 1400, a conversation database 1500, an output unit 1600, and a speech recognition dictionary memory 1700.

### [Input Unit]

The input unit 1100 receives input information (user's utterance) input by a user. The input unit 1100 outputs a speech corresponding to contents of the received utterance as a voice signal to the speech recognition unit 1200. Note that the input unit 1100 may be a character input unit such as a keyboard and a touchscreen (touch panel). In this case, the after-mentioned speech recognition unit 1200 doesn't need to be provided.

### [Speech Recognition Unit]

The speech recognition unit 1200 specifies a character string corresponding to the uttered contents based on the uttered contents obtained via the input unit 1100. Specifically, the speech recognition unit 1200 that has received the voice signal from the input unit 1100 compares the received voice signal with the conversation database 1500 and dictionaries stored in the speech recognition dictionary memory 1700 based on the voice signal to output a speech recognition result estimated based on the voice signal to the conversation control unit 1300. In a configuration example shown in FIG. 9, the speech recognition unit 1200 requests acquisition of memory contents of the conversation database 1500 to the conversation control unit 1300 and then receives the memory contents of the conversation database 1500 which the conversation control unit 1300 retrieves according to the request from the speech recognition unit 1200. However the speech recognition unit 1200 may directly retrieves the memory contents of the conversation database 1500 for comparing with the voice signal.

### [Configuration Example of Speech Recognition Unit]

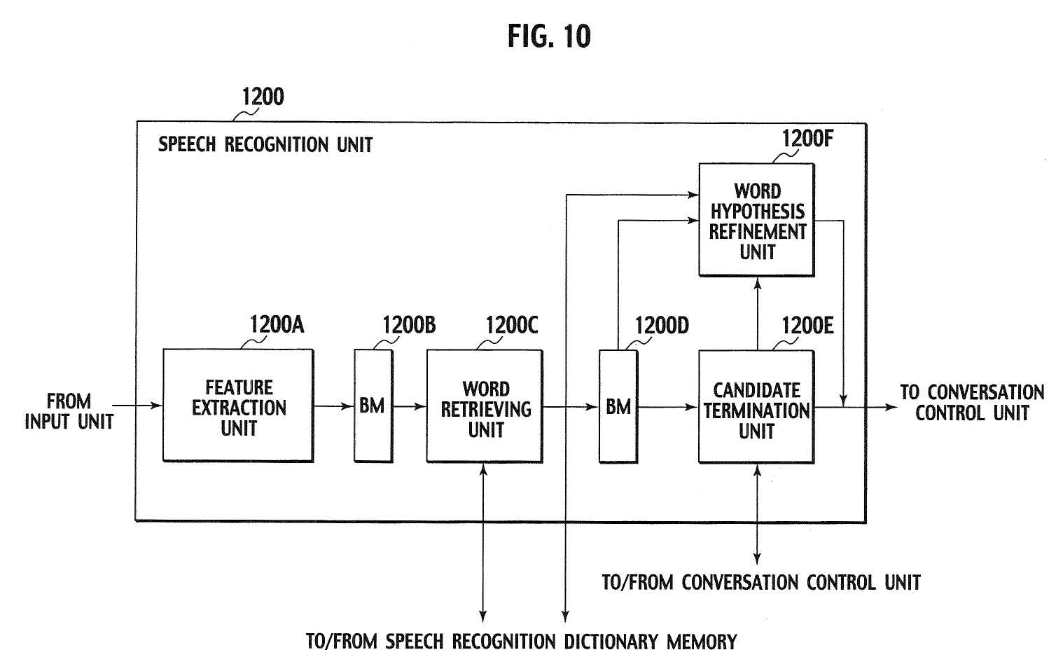

FIG. 10 is a functional block diagram showing a configuration example of the speech recognition unit 1200. The speech recognition unit 1200 includes a feature extraction unit 1200A, a buffer memory (BM) 1200B, a word retrieving unit 1200C, a buffer memory (BM) 1200D, a candidate determination unit 1200E and a word hypothesis refinement unit 1200F. The word retrieving unit 1200C and the word hypothesis refinement unit 1200F are connected to the speech recognition dictionary memory 1700. In addition, the candidate determination unit 1200E is connected to the conversation database 1500 via the conversation control unit 1300.

The speech recognition dictionary memory 1700 connected to the word retrieving unit 1200C stores a phoneme hidden markov model (hereinafter, the hidden markov model is referred as the HMM). The phoneme HMM is described with various states and each of the states includes the following information. It is configured with (a) a state number, (b) an acceptable context class, (c) lists of a previous state and a subsequent state, (d) parameters of an output probability density distribution, and (e) a self-transition probability and a transition probability to a subsequent state. The phoneme HMM used in the present embodiment is generated by converting a prescribed Speaker-Mixture HMM in order to specify which speakers respective distributions are derived from. An output probability density function is a Mixture Gaussian distribution with a 34-dimensional diagonal covariance matrix. The speech recognition dictionary memory 1700 connected to the word retrieving unit 1200C further stores a word dictionary. The word dictionary stores symbol strings each of which indicates a reading represented as a symbol per each word in the phoneme HMM.

A speaker's speech is input into a microphone or the like and then converted into a voice signal to be input to the feature extraction unit 1200A. The feature extraction unit 1200A converts the input voice signal from analog to digital and then extracts a feature parameter from the voice signal to output the feature parameter. There are various methods for extracting and outputting the feature parameter. For example, an LPC analysis is executed to extract a 34-dimensional feature parameter including a logarithm power, a 16-dimensional cepstrum coefficient, a Δ-logarithm power and a 16-dimensional Δ-cepstrum coefficient. The time series of the extracted feature parameters are input to the word retrieving unit 1200C via the buffer memory (BM) 1200B.

The word retrieving unit 1200C retrieves word hypotheses with a one-pass Viterbi decoding method based on the feature parameters input from the feature extraction unit 1200A via the buffer memory (BM) 1200B by using the phoneme HMM and the word dictionary stored in the speech recognition dictionary memory 1700, and then calculates likelihoods. Here, the word retrieving unit 1200C calculates a likelihood in a word and a likelihood from a speech start for each state of the phoneme HMM at each time. The likelihood is calculated each of an identification number of a calculating-object word, a speech start time of the word and a difference of a preceding word previously uttered before the word. The word retrieving unit 1200C may reduce grid hypotheses of the lower likelihoods among all of the calculated likelihoods based on the phoneme HMM and the word dictionary in order to reduce a computing throughput. The word retrieving unit 1200C outputs information on the retrieved word hypotheses and the likelihoods of the retrieved word hypotheses together with time information regarding an elapsed time from the speech start time (e.g. frame number) to the candidate determination unit 1200E and the word hypothesis refinement unit 1200F via the buffer memory (BM) 1200D.

The candidate determination unit 1200E compares the retrieved word hypotheses with topic specification information in a prescribed discourse space with reference to the conversation control unit 1300, and then determines whether or not exists a coincident word hypothesis with the topic specification information in the prescribed discourse space among the retrieved word hypotheses. If the coincident word hypothesis exists, the candidate determination unit 1200E outputs the coincident word hypothesis as a recognition result. On the other hand, if the coincident word hypothesis doesn't exist, the candidate determination unit 1200E requires the word hypothesis refinement unit 1200F to refine the retrieved word hypotheses.

An operation of the candidate determination unit 1200E will be described. Here, it is assumed that the word retrieving unit 1200C outputs plural word hypotheses (“KANTAKU (reclamation)”, “KATAKU (pretext)” and “KANTOKU (director)”) and plural likelihoods (recognition rates) for the respective word hypotheses; the prescribed discourse space relates to movies; the topic specification information of the prescribed discourse space includes “KANTOKU (director)” but neither “KANTAKU (reclamation)” nor “KATAKU (pretext)”; among the likelihoods (recognition rates) of “KANTAKU (reclamation)”, “KATAKU (pretext)” and “KANTOKU (director)”, “KANTAKU (reclamation)” is highest, “KANTOKU (director)” is lowest and “KATAKU (pretext)” is intermediate between the two.

The candidate determination unit 1200E compares the retrieved word hypotheses with the topic specification information in the prescribed discourse space, and then specifies the coincident word hypothesis “KANTOKU (director)” with the topic specification information to output the word hypothesis “KANTOKU (director)” to the conversation control unit 1300 as the recognition result. Processed in this manner, the word hypothesis “KANTOKU (director)” relating to the current topic “movies” is selected ahead of the word hypotheses “KANTAKU (reclamation)” and “KATAKU (pretext)” with higher likelihoods. As a result, the recognition result appropriate with the discourse context can be output.

On the other hand, if no coincident word hypothesis exists, the word hypothesis refinement unit 1200F operates to output the recognition result in response to the request from the candidate determination unit 1200E to refine the retrieved word hypotheses. The word hypothesis refinement unit 1200F refines the retrieved word hypotheses for the same words having the same speech termination time and different speech start time per each initial phonetic environment of the same words with reference to a statistical language model stored in the speech recognition dictionary memory 1700 based on the plural retrieved word hypotheses output from the word retrieving unit 1200C via the buffer memory (BM) 1200D so that one word hypothesis with the highest likelihood may be selected as a representative among all of the likelihoods calculated between the speech start and the utterance termination of the word. And then, the word hypothesis refinement unit 1200F outputs one word string of the one word hypothesis with the highest likelihood as the recognition result among all word strings of the refined word hypotheses. In the present embodiment, the initial phonetic environment of the same word to be processed is preferably defined with a three-phoneme series containing the last phoneme of the word hypothesis preceding the same word and two initial phonemes of the word hypothesis of the same word.

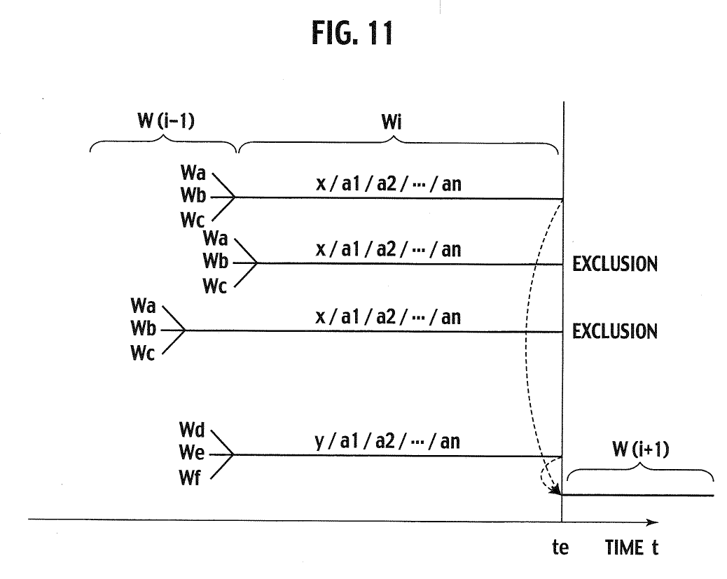

A word refinement process executed by the word hypothesis refinement unit 1200F will be described with reference to FIG. 11.

For example, it is assumed that the (i)th word Wi, which consists of a phonemic string a1, a2, . . . and an, follows the (i-1)th word W(i-1) and six hypotheses Wa, Wb, Wc, Wd, We and Wf exist as a word hypothesis of the (i-1)th word W(i-1). It is further assumed that the last phoneme of the former three word hypotheses Wa, Wb and Wc is /x/, and the last phoneme of the latter three word hypotheses Wd, We and Wf is /y/. If three hypotheses each premised on three word hypotheses Wa, Wb and Wc and also one hypothesis premised on three word hypotheses Wd, We and Wf remain at the speech termination time te, the word hypothesis refinement unit 1200F is selected one hypothesis with the highest likelihood among the former three hypotheses with the same initial phonetic environment, and other two hypotheses are excluded.

Note that, since the initial phonetic environment of the hypothesis premised on the word hypotheses Wd, We and Wf is different from those of the other three hypotheses, that is, the last phoneme of the preceded word hypothesis is not /x/ but /y/, the hypothesis premised on the word hypotheses Wd, We and Wf is not excluded. In other words, one hypothesis is kept for each of the last phonemes of the preceding word hypotheses.

In the present embodiment, the initial phonetic environment of the word is defined with a three-phoneme series containing the last phoneme of the word hypothesis preceding the word and two initial phonemes of the word hypothesis of the word. However, the present invention is not limited to this. The initial phonetic environment of the word may be defined with a phoneme series containing a phoneme string of the preceding word hypothesis including the last phoneme of the preceding word hypothesis and at least one serial phoneme with the last phoneme of the preceding word hypothesis and a phoneme string including the first phoneme of the word hypothesis of the word.

In the present embodiment, the feature extraction unit 1200A, the word retrieving unit 1200C, the candidate determination unit 1200E and the word hypothesis refinement unit 1200F are composed of a computer such as a microcomputer. The buffer memories (BMs) 200B and 200D and the speech recognition dictionary memory 1700 are composed of a memory unit such as a hard disk storage.

In the above-mentioned embodiment, the speech recognition is executed by using the word retrieving unit 1200C and the word hypothesis refinement unit 1200F. However, the present invention is not limited to this. The speech recognition unit 1200 may be composed of a phoneme comparison unit for referring to the phoneme HMM and a speech recognition unit for executing the speech recognition of a ward with reference to a statistical language model by using, for example, a One Pass DP algorithm.

In addition, in the present embodiment, the speech recognition unit 1200 is explained as a part of the conversation controller 1000. However, a independent speech recognition apparatus configured by the speech recognition unit 1200, the conversation database 1500 and the speech recognition dictionary memory 1700 may be possibly employed.

### [Operating Example of Speech Recognition Unit]

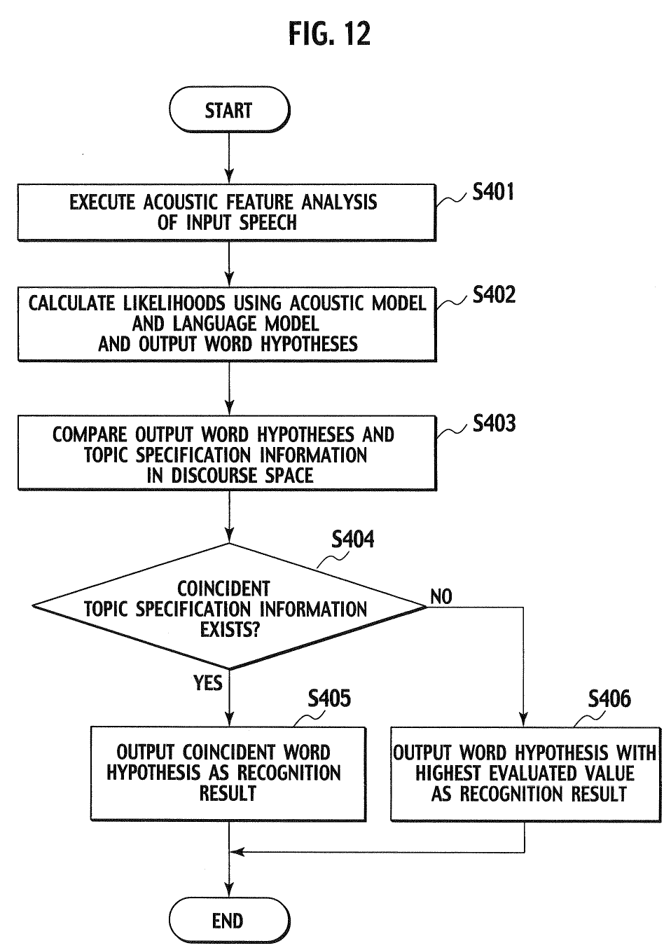

Next, operations of the speech recognition unit 1200 will be described with reference to FIG. 12. FIG. 12 is a flow-chart showing process operations of the speech recognition unit 1200.

The speech recognition unit 1200 executes a feature analysis of the input speech to generate feature parameters on receiving the voice signal from the input unit 1100 (step S401). Next, the feature parameters is compared with the phoneme HMM and the language model stored in the speech recognition dictionary memory 1700, and then a certain number of word hypotheses and the likelihoods of the word hypotheses are obtained (step S402). Next, the speech recognition unit 1200 compares the obtained certain number of word hypotheses, the retrieved word hypotheses and the topic specification information in the prescribed discourse space to determine whether or not the coincident word hypothesis with the topic specification information in the prescribed discourse space exists among the retrieved word hypotheses (steps S403 and S404). If the coincident word hypothesis exists, the speech recognition unit 1200 outputs the coincident word hypothesis as the recognition result (step S405). On the other hand, if no coincident word hypothesis exists, the speech recognition unit 1200 outputs the word hypothesis with the highest likelihood as the recognition result according to the obtained likelihoods of the word hypotheses (step S406).

### [Speech Recognition Dictionary Memory]

The configuration example of the conversation controller 1000 is further described with referring back to FIG. 9 again.

The speech recognition dictionary memory 1700 stores character strings corresponding to standard voice signals. The speech recognition unit 1200, which has executed the comparison, specifies a word hypothesis for a character string corresponding to the received voice signal, and then outputs the specified word hypothesis as a character string signal to the conversation control unit 1300.

### [Sentence Analyzing Unit]

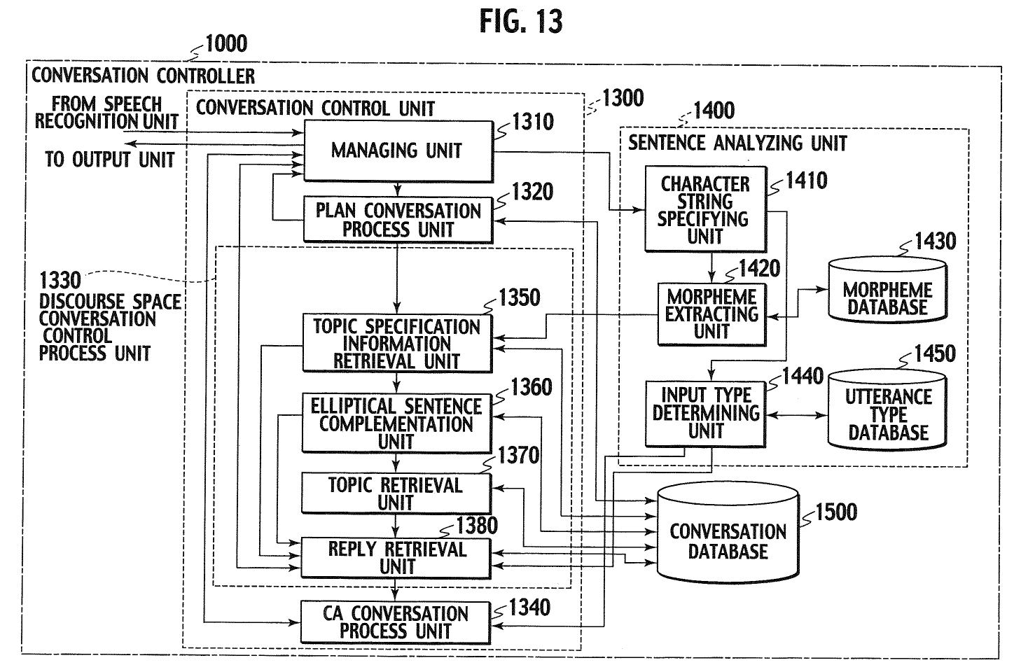

Next, a configuration example of the sentence analyzing unit 1400 will be described with reference to FIG. 13. FIG. 13 is a partly enlarged block diagram of the conversation controller 1000 and also a block diagram showing a concrete configuration example of the conversation control unit 1300 and the sentence analyzing unit 1400. Note that only the conversation control unit 1300, the sentence analyzing unit 1400 and the conversation database 1500 are shown in FIG. 13 and the other components are omitted to be shown.

The sentence analyzing unit 1400 analyses a character string specified at the input unit 1100 or the speech recognition unit 1200. In the present embodiment as shown in FIG. 13, the sentence analyzing unit 1400 includes a character string specifying unit 1410, a morpheme extracting unit 1420, a morpheme database 1430, an input type determining unit 1440 and an utterance type database 1450. The character string specifying unit 1410 segments a series of character strings specified by the input unit 1100 or the speech recognition unit 1200 into segments. Each segment is a minimum segmented sentence which is segmented in the extent to keep a grammatical meaning. Specifically, if the series of the character strings have a time interval more than a certain interval, the character string specifying unit 1410 segments the character strings there. The character string specifying unit 1410 outputs the segmented character strings to the morpheme extracting unit 1420 and the input type determining unit 1440. Note that a “character string” to be described below means one segmented character string.

### [Morpheme Extracting Unit]

The morpheme extracting unit 1420 extracts morphemes constituting minimum units of the character string as first morpheme information from each of the segmented character strings based on each of the segmented character strings segmented by the character string specifying unit 1410. In the present embodiment, a morpheme means a minimum unit of a word structure shown in a character string. For example, each minimum unit of a word structure may be a word class such as a noun, an adjective and a verb.

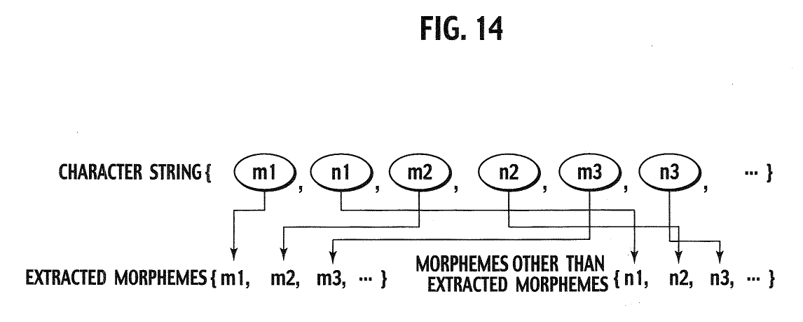

In the present embodiment as shown in FIG. 14, the morphemes are indicated as m1, m2, m3, . . . . FIG. 14. is a diagram showing a relation between a character string and morphemes extracted from the character string. The morpheme extracting unit 1420, which has received the character strings from the character string specifying unit 1410, compares the received character strings and morpheme groups previously stored in the morpheme database 1430 (each of the morpheme group is prepared as a morpheme dictionary in which a direction word, a reading, a word class and infected forms are described for each morpheme belonging to each word-class classification) as shown in FIG. 14. The morpheme extracting unit 1420, which has executed the comparison, extracts coincident morphemes (m1, m2, . . . ) with any of the stored morpheme groups from the character strings. Other morphemes (n1, n2, n3, . . . ) than the extracted morphemes may be auxiliary verbs, for example.

The morpheme extracting unit 1420 outputs the extracted morphemes to a topic specification information retrieval unit 1350 as the first morpheme information. Note that the first morpheme information is not needed to be structurized. Here, “structurizing” means classifying and arranging morphemes included in a character string based on word classes. For example, it may be data conversion in which a character string as an uttered sentence is segmented into morphemes and then the morphemes are arranged in a prescribed order such as “Subject+Object+Predicate”. Needless to say, the structurized first morpheme information doesn't prevent the operations of the present embodiment.

### [Input Type Determining Unit]

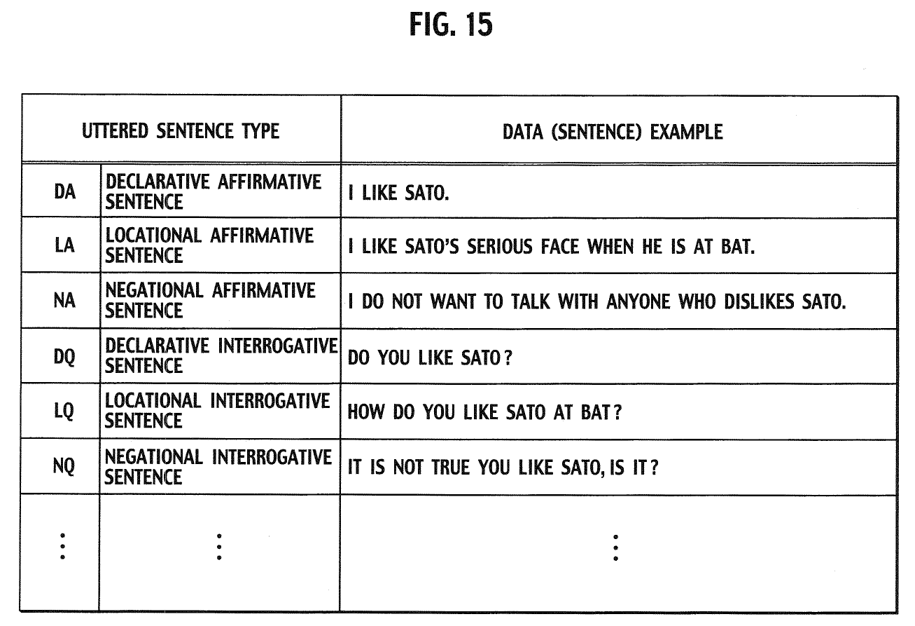

The input type determining unit 1440 determines an uttered contents type (utterance type) based on the character strings specified by the character string specifying unit 1410. In the present embodiment, the utterance type is information for specifying the uttered contents type and, for example, corresponds to “uttered sentence type” shown in FIG. 15. FIG. 15 is a table showing the “uttered sentence types”, two-alphabet codes representing the uttered sentence types, and uttered sentence examples corresponding to the uttered sentence types.

Here in the present embodiment as shown in FIG. 15, the “uttered sentence types” include declarative sentences (D: Declaration), time sentences (T: Time), locational sentences (L: Location), negational sentences (N: Negation) and so on. A sentence configured by each of these types is an affirmative sentence or an interrogative sentence. A “declarative sentence” means a sentence showing a user's opinion or notion. In the present embodiment, one example of the “declarative sentence” is the sentence “I like Sato” shown in FIG. 15. A “locational sentence” means a sentence involving a location concept. A “time sentence” means a sentence involving a time concept. A “negational sentence” means a sentence to deny a declarative sentence. Sentence examples of the “uttered sentence types” are shown in FIG. 15.

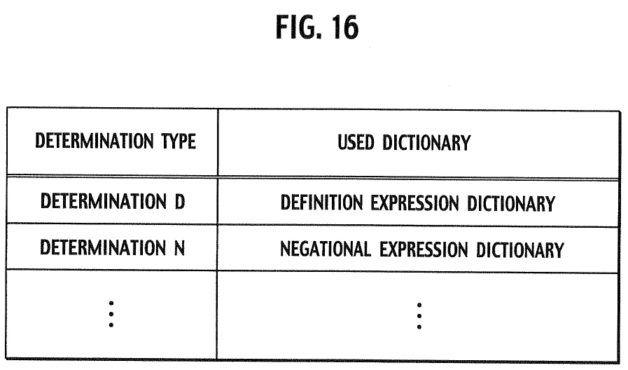

In the present embodiment as shown in FIG. 16, the input type determining unit 1440 uses a declarative expression dictionary for determination of a declarative sentence, a negational expression dictionary for determination of a negational sentence and so on in order to determine the “uttered sentence type”. Specifically, the input type determining unit 1440, which has received the character strings from the character string specifying unit 1410, compares the received character strings and the dictionaries stored in the utterance type database 1450 based on the received character string. The input type determining unit 1440, which has executed the comparison, extracts elements relevant to the dictionaries among the character strings.

The input type determining unit 1440 determines the “uttered sentence type” based on the extracted elements. For example, if the character string includes elements declaring an event, the input type determining unit 1440 determines that the character string including the elements is a declarative sentence. The input type determining unit 1440 outputs the determined “uttered sentence type” to a reply retrieval unit 1380.

### [Conversation Database]

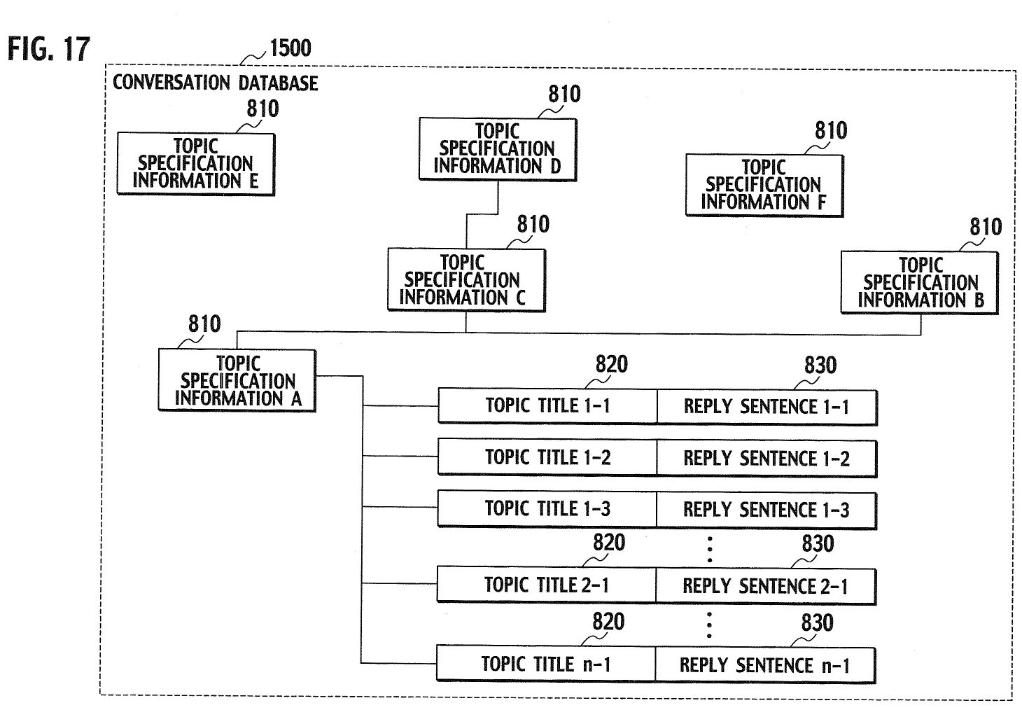

A configuration example of data structure stored in the conversation database 1500 will be described with reference to FIG. 17. FIG. 17 is a conceptual diagram showing the configuration example of data stored in the conversation database 1500.

As shown in FIG. 17, the conversation database 1500 stores a plurality of topic specification information 810 for specifying a conversation topic. In addition, topic specification information 810 can be associated with other topic specification information 810. For example, if topic specification information C (810) is specified, three of topic specification information A (810), B (810) and D (810) associated with the topic specification information C (810) are also specified.

Specifically in the present embodiment, topic specification information 810 means “keywords” which are relevant to input contents expected to be input from users or relevant to reply sentences to users.

The topic specification information 810 is associated with one or more topic titles 820. Each of the topic titles 820 is configured with a morpheme composed of one character, plural character strings or a combination thereof. A reply sentence 830 to be output to users is stored in association with each of the topic titles 820. Response types indicate types of the reply sentences 830 and are associated with the reply sentences 830, respectively.

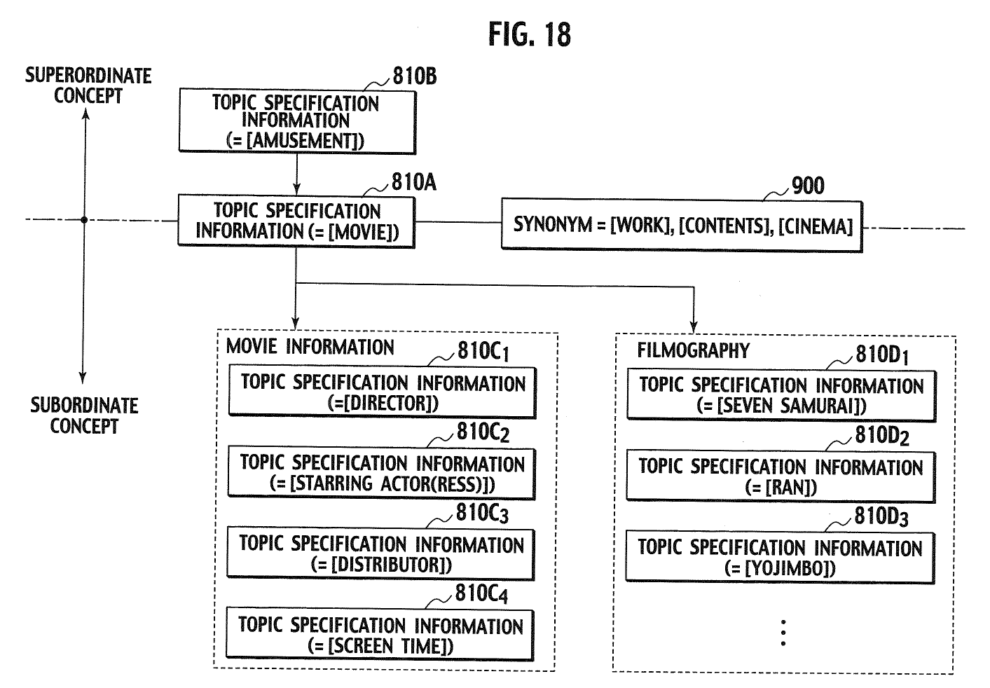

Next, an association between the topic specification information 810 and the other topic specification information 810 will be described. FIG. 18 is a diagram showing the association between certain topic specification information 810A and the other topic specification information 810B, 810C₁-810C₄ and 810D₁-810D₃ . . . . Note that a phrase “stored in association with” mentioned below indicates that, when certain information X is read out, information Y stored in association with the information X can be also read out. For example, a phrase “information Y is stored ‘in association with’ the information X” indicates a state where information for reading out the information Y (such as, a pointer indicating a storing address of the information Y, a physical memory address or a logical address in which the information Y is stored, and so on) is implemented in the information X.

In the example shown in FIG. 18, the topic specification information can be stored in association with the other topic specification information with respect to a superordinate concept, a subordinate concept, a synonym or an antonym (not shown in FIG. 18). For example as shown in FIG. 18, the topic specification information 810B (amusement) is stored in association with the topic specification information 810A (movie) as a superordinate concept and stored in a higher level than the topic specification information 810B (amusement).

In addition, subordinate concepts of the topic specification information 810A (movie), the topic specification information 810C₁ (director), 810C₂ (starring actor[ress]), 810C₃ (distributor), 810C₄ (screen time), 810D₁ (“Seven Samurai”), 810D₂ (“Ran”), 810D₃ (“Yojimbo”), . . . , are stored in association with the topic specification information 810A.

In addition, synonyms 900 are associated with the topic specification information 810A. In this example, “work”, “contents” and “cinema” are stored as synonyms of “movie” which is a keyword of the topic specification information 810A. By defining these synonyms in this manner, the topic specification information 810A can be treated as included in an uttered sentence even though the uttered sentence doesn't include the keyword “movie” but includes “work”, “contents” or “cinema”.

In the conversation controller 1000 according to the present embodiment, when certain topic specification information 810 has been specified with reference to contents stored in the conversation database 1500, other topic specification information 810 and the topic titles 820 or the reply sentences 830 of the other topic specification information 810, which are stored in association with the certain topic specification information 810, can be retrieved and extracted rapidly.

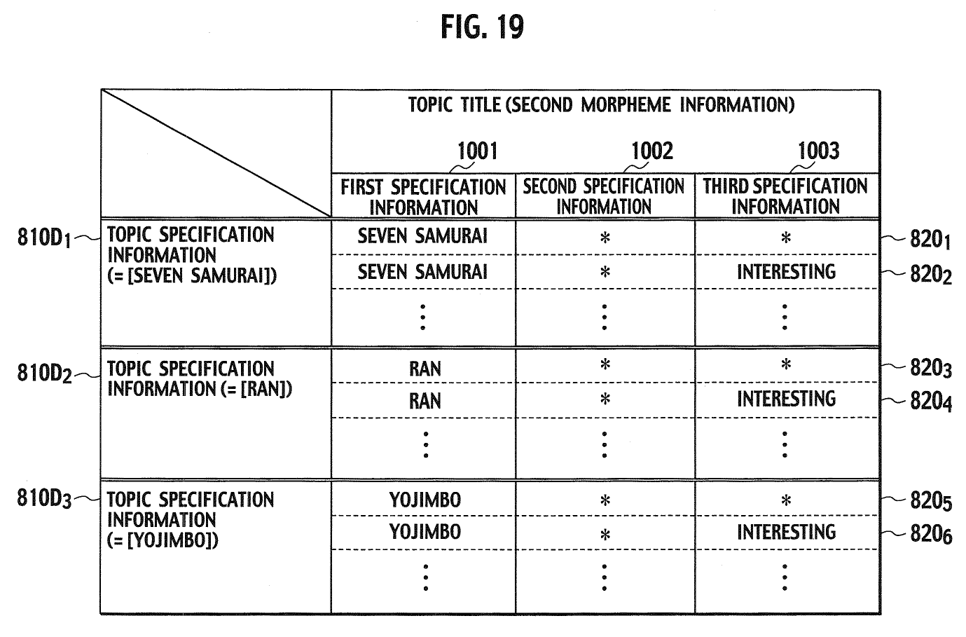

Next, data configuration examples of topic titles 820 (also referred as “second morpheme information”) will be described with reference to FIG. 19. FIG. 19 is a diagram showing the data configuration examples of the topic titles 820.

The topic specification information 810D₁, 810D₂, 810D₃, . . . , include the topic titles 820₁, 820₂, . . . , the topic titles 820₃, 820₄, . . . , the topic titles 820₅, 820₆, . . . , respectively. In the present embodiment as shown in FIG. 19, each of the topic titles 820 is information composed of first specification information 1001, second specification information 1002 and third specification information 1003. Here, the first specification information 1001 is a main morpheme constituting a topic. For example, the first specification information 1001 may be a Subject of a sentence. In addition, the second specification information 1002 is a morpheme closely relevant to the first specification information 1001. For example, the second specification information 1002 may be an Object. Furthermore, the third specification information 1003 in the present embodiment is a morpheme showing a movement of a certain subject, a morpheme of a noun modifier and so on. For example, the third specification information 1003 may be a verb, an adverb or an adjective. Note that the first specification information 1001, the second specification information 1002 and the third specification information 1003 are not limited to the above meanings. The present embodiment can be effected in case where contents of a sentence can be understood based on the first specification information 1001, the second specification information 1002 and the third specification information 1003 even though they are give other meanings (other ward classes).

For example as shown in FIG. 19, if the Subject is “Seven Samurai” and the adjective is “interesting”, the topic title 820₂ (second morpheme information) consists of the morpheme “Seven Samurai” included in the first specification information 1001 and the morpheme “interesting” included in the third specification information 1003. Note that the second specification information 1002 of this topic title 820₂ includes no morpheme and a symbol “*” is stored in the second specification information 1002 for indicating no morpheme included.

Note that this topic title 820₂ (Seven Samurai; *; interesting) has the meaning of “Seven Samurai is interesting.” Hereinafter, parenthetic contents for a topic title 820₂ indicate the specification information 1001, the second specification information 1002 and the third specification information 1003 from the left. In addition, when no morpheme is included in any of the first to third specification information, “*” is indicated therein.

Note that the specification information constituting the topic titles 820 is not limited to three and other specification information (fourth specification information and more) may be included.

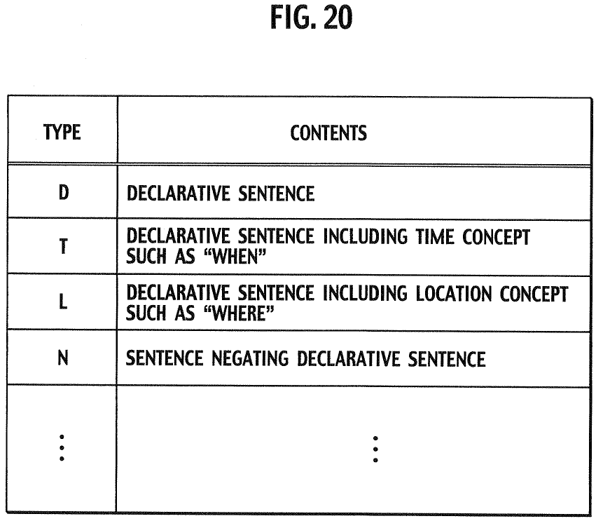

The reply sentences 830 will be described with reference to FIG. 20. In the present embodiment as shown in FIG. 20, the reply sentences 830 are classified into different types (response types) such as declaration (D: Declaration), time (T: Time), location (L: Location) and negation (N: Negation) for making a reply corresponding to the uttered sentence type of the user's utterance. Note that an affirmative sentence is classified with “A” and an interrogative sentence is classified with “Q”.

A configuration example of data structure of the topic specification information 810 will be described with reference to FIG. 21. FIG. 21 shows a concrete example of the topic titles 820 and the reply sentences 830 associated with the topic specification information 810 “Sato”.

The topic specification information 810 “Sato” is associated with plural topic titles (820) 1-1, 1-2, . . . . Each of the topic titles (820) 1-1, 1-2, . . . is associated with reply sentences (830) 1-1, 1-2, . . . . The reply sentence 830 is prepared per each of the response types 840.

For example, when the topic title (820) 1-1 is (Sato; *; like) [these are extracted morphemes included in “I like Sato”], the reply sentences (830) 1-1 associated with the topic title (820) 1-1 include (DA: a declarative affirmative sentence “I like Sato, too.”) and (TA: a time affirmative sentence “I like Sato at bat.”). The after-mentioned reply retrieval unit 1380 retrieves one reply sentence 830 associated with the topic title 820 with reference to an output from the input type determining unit 1440.

Next-plan designation information 840 is allocated to each of the reply sentences 830. The next-plan designation information 840 is information for designating a reply sentence to be preferentially output against a user's utterance in association with the each of the reply sentences (referred as a “next-reply sentence”). The next-plan designation information 840 may be any information even if a next-reply sentence can be specified by the information. For example, the information may be a reply sentence ID, by which at least one reply sentence can be specified among all reply sentences stored in the conversation database 1500.

In the present embodiment, the next-plan designation information 840 is described as information for specifying one next-reply sentence per one reply sentence (for example, a reply sentence ID). However, the next-plan designation information 840 may be information for specifying next-reply sentences per topic specification information 810 or per one topic title 820. (In this case, since plural replay sentences are designated, they are referred as a “next-reply sentence group”. However, only one of the reply sentences included in the next-reply sentence group will be actually output as the reply sentence.) For example, the present embodiment can be effected in case where a topic title ID or a topic specification information ID is used as the next-plan designation information.

### [Conversation Control Unit]

A configuration example of the conversation control unit 1300 is further described with referring back to FIG. 13.

The conversation control unit 1300 functions to control data transmitting between configuration components in the conversation controller 1000 (the speech recognition unit 1200, the sentence analyzing unit 1400, the conversation database 1500, the output unit 1600 and the speech recognition dictionary memory 1700), and determine and output a reply sentence in response to a user's utterance.

In the present embodiment shown in FIG. 13, the conversation control unit 1300 includes a managing unit 1310, a plan conversation process unit 1320, a discourse space conversation control process unit 1330 and a CA conversation process unit 1340. Hereinafter, these configuration components will be described.

### [Managing Unit]

The managing unit 1310 functions to store discourse histories and update, if needed, the discourse histories. The managing unit 1310 further functions to transmit some or entire of the stored discourse histories to a part or a whole of the discourse histories to a topic specification information retrieval unit 1350, an elliptical sentence complementation unit 1360, a topic retrieval unit 1370 or a reply retrieval unit 1380 in response to a request therefrom.

### [Plan Conversation Process Unit]

The plan conversation process unit 1320 functions to execute plans and establish conversations between a user and the conversation controller 1000 according to the plans. A “plan” means providing a predetermined reply to a user in a predetermined order.

The plan conversation process unit 1320 functions to output the predetermined reply in the predetermined order in response to a user's utterance.

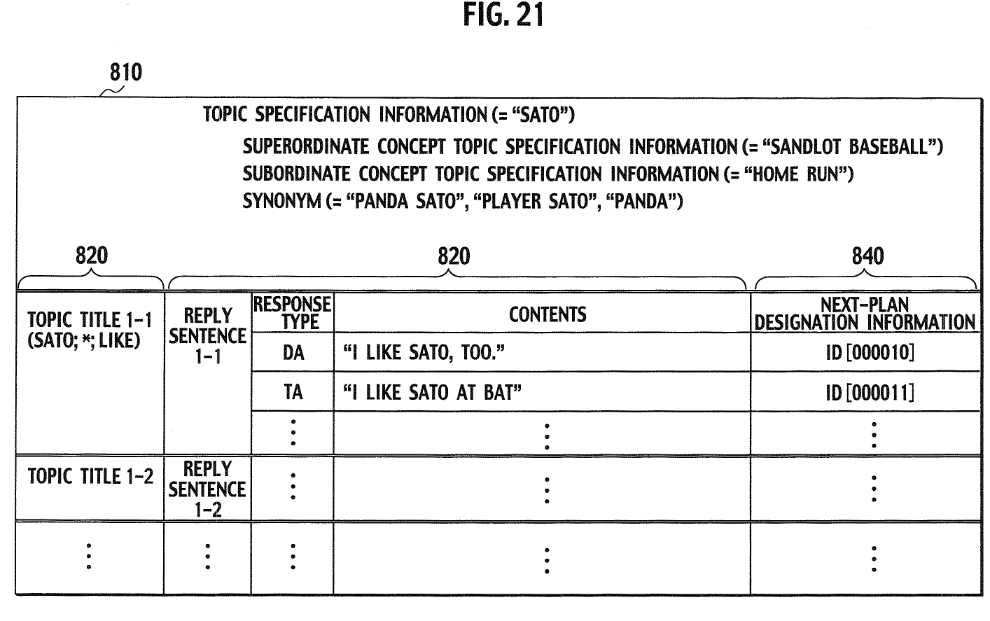

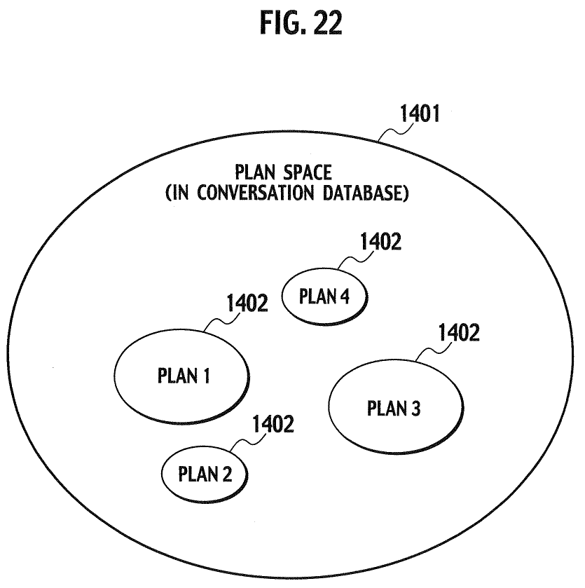

FIG. 22 is a conceptual diagram to describe plans. As shown in FIG. 22, various plans 1402 such as plural plans 1, 2, 3 and 4 are prepared in a plan space 1401. The plan space 1401 is a set of the plural plans 1402 stored in the conversation database 1500. The conversation controller 1000 selects a preset plan 1402 for a start-up on an activation or a conversation start or arbitrarily selects one of the plans 1402 in the plan space 1401 in response to a user's utterance contents in order to output a reply sentence against the user's utterance by using the selected plan 1402.

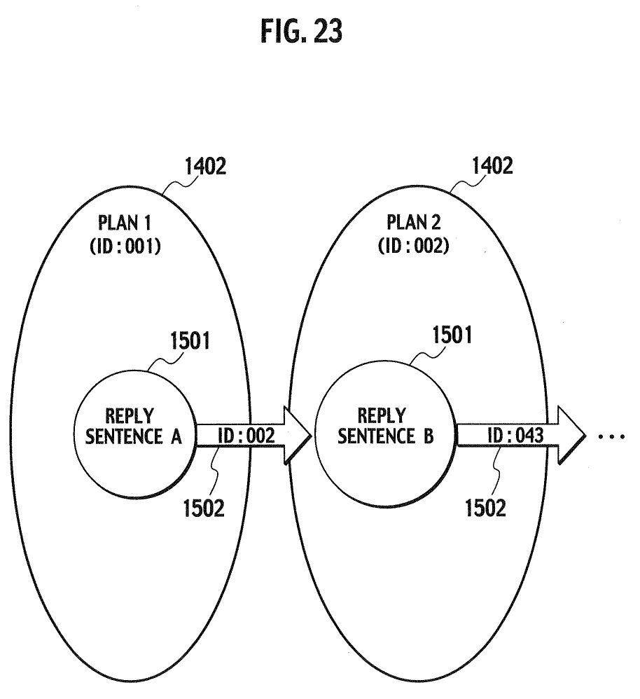

FIG. 23 shows a configuration example of plans 1402. Each plan 1402 includes a reply sentence 1501 and next-plan designation information 1502 associated therewith. The next-plan designation information 1502 is information for specifying, in response to a certain reply sentence 1501 in a plan 1402, another plan 1402 including a reply sentence to be output to a user (referred as a “next-reply candidate sentence”). In this example, the plan 1 includes a reply sentence A (1501) to be output at an execution of the plan 1 by the conversation controller 1000 and next-plan designation information 1502 associated with the reply sentence A (1501). The next-plan designation information 1502 is information [ID: 002] for specifying a plan 2 including a reply sentence B (1501) to be a next-reply candidate sentence to the reply sentence A (1501). Similarly, since the reply sentence B (1501) is also associated with next-plan designation information 1502, another plan 1402 [ID: 043] including the next-reply candidate sentence will be designated when the reply sentence B (1501) has output. In this manner, plans 1402 are chained via next-plan designation information 1502 and plan conversations in which a series of successive contents can be output to a user.

In other words, since contents expected to be provided to a user (an explanatory sentence, an announcement sentence, a questionnaire and so on) are separated into plural reply sentences and the reply sentences are prepared as a plan with their order predetermined, it becomes possible to provide a series of the reply sentences to the user in response to the user's utterances. Note that a reply sentence 1501 included in a plan 1402 designated by next-plan designation information 1502 is not needed to be output to a user immediately after an output of the user's utterance in response to an output of a previous reply sentence. The reply sentence 1501 included in the plan 1402 designated by the next-plan designation information 1502 may be output after an intervening conversation on a different topic from a topic in the plan between the conversation controller 1000 and the user.

Note that the reply sentence 1501 shown in FIG. 23 corresponds to a sentence string of one of the reply sentences 830 shown in FIG. 21. In addition, the next-plan designation information 1502 shown in FIG. 23 corresponds to the next-plan designation information 840 shown in FIG. 21.

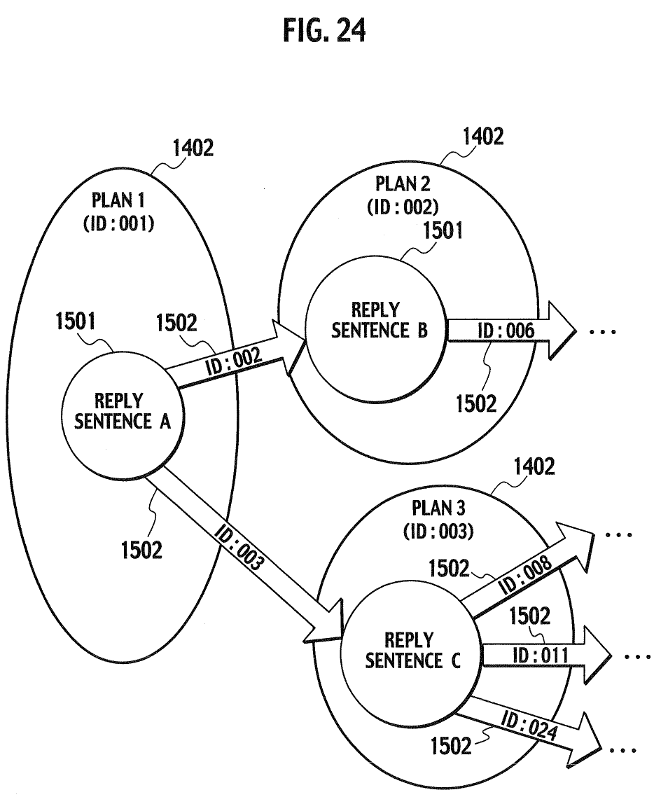

Note that linkages between the plans 1402 are not limited to form a one-dimensional geometry shown in FIG. 23. FIG. 24 shows an example of plans 1402 with another linkage geometry. In the example shown in FIG. 24, a plan 1 (1402) includes two of next-plan designation information 1502 to designate two reply sentences as next replay candidate sentences, in other words, to designate two plans 1402. The two of next-plan designation information 1502 are prepared in order that the plan 2 (1402) including a reply sentence B (1501) and the plan 3 (1402) including a reply sentence C (1501) are to be designated as plans each including a next-reply candidate sentence. Note that the reply sentences are selective and alternative, so that, when one has been output, another is not output and then the plan 1 (1501) is terminated. In this manner, the linkages between the plans 1402 is not limited to forming a one-dimensional geometry and may form a tree-diagram-like geometry or a cancellous geometry.

Note that it is not limited that how many next-reply candidate sentences each plan 1402 includes. In addition, no next-plan designation information 1502 may be included in a plan 1402 which terminates a conversation.

FIG. 25 shows an example of a certain series of plans 1402. As shown in FIG. 25, this series of plans 1402₁ to 1402₄ are associated with reply sentences 1501₁ to 1501₄ which notify crisis management information to a user. The reply sentences 1501₁ to 1501₄ constitute one coherent topic as a whole. Each of the plans 1402₁ to 1402₄ includes ID data 1702₁ to 1702₄ for indicating itself such as “1000-01, 1000-02”, “1000-03” and “1000-04”, respectively. In addition, each of the plans 1402₁ to 1402₄ further includes ID data 1502₁ to 1502₄ as the next-plan designation information such as “1000-02, 1000-03”, “1000-04” and “1000-0F”, respectively. Note that each value after a hyphen in the ID data is information indicating an output order. Especially, “0F” is information indicating the final plan (the last in the order).

In this example, the plan conversation process unit 1320 starts to execute this series of plans when a user has uttered's utterance has been “Please tell me a crisis management applied when a large earthquake occurs.” Specifically, the plan conversation process unit 1320 searches in the plan space 1401 and checks whether or not a plan 1402 including a reply sentence 1501₁ associated with the user's utterance “Please tell me a crisis management applied when a large earthquake occurs,” when the plan conversation process unit 1320 has received the user's utterance “Please tell me a crisis management applied when a large earthquake occurs.” In this example, a user's utterance character string 1701₁ associated with the user's utterance “Please tell me a crisis management applied when a large earthquake occurs,” is associated with a plan 1402₁.

The plan conversation process unit 1320 retrieves the reply sentence 1501₁ included in the plan 1402₁ on discovering the plan 1402₁ and outputs the reply sentence 1501₁ to the user as a reply sentence in response to the user's utterance. And then, the plan conversation process unit 1320 specifies the next-reply candidate sentence with reference to the next-plan designation information 1502₁.

Next, the plan conversation process unit 1320 executes the plan 1402₂ on receiving another user's utterance via the input unit 1100, a speech recognition unit 1200 or the like after an output of the reply sentence 1501₁. Specifically, the plan conversation process unit 1320 judges whether or not to execute the plan 1402₂ designated by the next-plan designation information 1502₁, in other words, whether or not to output the second reply sentence 1501₂. More specifically, the plan conversation process unit 1320 compares a user's utterance character string (also referred as an illustrative sentence) 1701₂ associated with the reply sentence 1501₂ and the received user's utterance, or compares a topic title 820 (not shown in FIG. 25) associated with the reply sentence 1501₂ and the received user's utterance. And then, the plan conversation process unit 1320 determines whether or not the two are related to each other. If the two are related to each other, the plan conversation process unit 1320 outputs the second reply sentence 1501₂. In addition, since the plan 1402₂ including the second reply sentence 1501₂ also includes the next-plan designation information 1502₂, the next-reply candidate sentence is specified.

Similarly, according to ongoing user's utterances, the plan conversation process unit 1320 transit into the plans 1402₃ and 1402₄ in turn and can output the third and fourth reply sentences 1501₃ and 1501₄. Note that, since the fourth reply sentence 1501₄ is the final reply sentence, the plan conversation process unit 1320 terminates plan-executions when the fourth reply sentence 1501₄ has been output.

In this manner, the plan conversation process unit 1320 can provide previously prepared conversation contents to the user in a predetermined order by sequentially executing the plans 1402₁ to 1402₄.

### [Discourse Space Conversation Control Process Unit]

The configuration example of the conversation control unit 1300 is further described with referring back to FIG. 13.

The discourse space conversation control process unit 1330 includes the topic specification information retrieval unit 1350, the elliptical sentence complementation unit 1360, the topic retrieval unit 1370 and the reply retrieval unit 1380. The managing unit 1310 totally controls the conversation control unit 1300.

A “discourse history” is information for specifying a conversation topic or theme between a user and the conversation controller 1000 and includes at least one of “focused topic specification information”, a “focused topic title”, “user input sentence topic specification information” and “reply sentence topic specification information”. The “focused topic specification information”, the “focused topic title” and the “reply sentence topic specification information” are not limited to be defined from a conversation done just before but may be defined from the previous “focused topic specification information”, the “focused topic title” and the “reply sentence topic specification information” during a predetermined past period or from an accumulated record thereof.

Hereinbelow, each of the units constituting the discourse space conversation control process unit 1330 will be described.

### [Topic Specification Information Retrieval Unit]

The topic specification information retrieval unit 1350 compares the first morpheme information extracted by the morpheme extracting unit 1420 and the topic specification information, and then retrieves the topic specification information corresponding to a morpheme in the first morpheme information among the topic specification information. Specifically, when the first morpheme information received from the morpheme extracting unit 1420 is two morphemes “Sato” and “like”, the topic specification information retrieval unit 1350 compares the received first morpheme information and the topic specification information group.

If a focused topic title 820focus (indicated as 820focus to be differentiated from previously retrieved topic titles or other topic titles) includes a morpheme (for example, “Sato”) in the first morpheme information, the topic specification information retrieval unit 1350 outputs the focused topic title 820focus to the reply retrieval unit 1380. On the other hand, if no focused topic title 820focus includes the morpheme in the first morpheme information, the topic specification information retrieval unit 1350 determines user input sentence topic specification information based on the received first morpheme information, and then outputs the first morpheme information and the user input sentence topic specification information to the elliptical sentence complementation unit 1360. Note that the “user input sentence topic specification information” is topic specification information corresponding-to or probably-corresponding-to a morpheme relevant to topic contents talked by a user among morphemes included in the first morpheme information.

### [Elliptical Sentence Complementation Unit]

The elliptical sentence complementation unit 1360 generates various complemented first morpheme information by complementing the first morpheme information with the previously retrieved topic specification information 810 (hereinafter referred as the “focused topic specification information”) and the topic specification information 810 included in the final reply sentence (hereinafter referred as the “reply sentence topic specification information”). For example, if a user's utterance is “like”, the elliptical sentence complementation unit 1360 generates the complemented first morpheme information “Sato, like” by including the focused topic specification information “Sato” into the first morpheme information “like”.

In other words, if it is assumed that the first morpheme information is defined as “W” and a set of the focused topic specification information and the reply sentence topic specification information is defined as “D”, the elliptical sentence complementation unit 1360 generates the complemented first morpheme information by including an element(s) in the set “D” into the first morpheme information “W”.

In this manner, in case where, for example, a sentence constituted with the first morpheme information is an elliptical sentence which is unclear as a language, the elliptical sentence complementation unit 1360 can include, by using the set “D”, an element(s) (for example, “Sato”) in the set “D” into the first morpheme information “W”. As a result, the elliptical sentence complementation unit 1360 can complement the first morpheme information “like” into the complemented first morpheme information “Sato, like”. Note that the complemented first morpheme information “Sato, like” corresponds to a user's utterance “I like Sato.”

That is, even when user's utterance contents are provided as an elliptical sentence, the elliptical sentence complementation unit 1360 can complement the elliptical sentence by using the set “D”. As a result, even when a sentence constituted with the first morpheme information is an elliptical sentence, the elliptical sentence complementation unit 1360 can complement the sentence into an appropriate sentence as a language.

In addition, the elliptical sentence complementation unit 1360 retrieves the topic title 820 related to the complemented first morpheme information based on the set “D”. If the topic title 820 related to the complemented first morpheme information has been found, the elliptical sentence complementation unit 1360 outputs the topic title 820 to the reply retrieval unit 1380. The reply retrieval unit 1380 can output a reply sentence 830 best-suited for the user's utterance contents based on the appropriate topic title 820 found by the elliptical sentence complementation unit 1360.

Note that the elliptical sentence complementation unit 1360 is not limited to including an element(s) in the set “D” into the first morpheme information. The elliptical sentence complementation unit 1360 may include, based on a focused topic title, a morpheme(s) included in any of the first, second and third specification information in the topic title, into the extracted first morpheme information.

### [Topic Retrieval Unit]

The topic retrieval unit 1370 compares the first morpheme information and topic titles 820 associated with the user input sentence topic specification information to retrieve a topic title 820 best-suited for the first morpheme information among the topic titles 820 when the topic title 820 has not been determined by the elliptical sentence complementation unit 1360.

Specifically, the topic retrieval unit 1370, which has received a retrieval command signal from the elliptical sentence complementation unit 1360, retrieves the topic title 820 best-suited for the first morpheme information among the topic titles associated with the user input sentence topic specification information based on the user input sentence topic specification information and the first morpheme information which are included in the received retrieval command signal. The topic retrieval unit 1370 outputs the retrieved topic title 820 as a retrieval result signal to the reply retrieval unit 1380.

Above-mentioned FIG. 21 shows the concrete example of the topic titles 820 and the reply sentences 830 associated with the topic specification information 810 (=“Sato”). For example as shown in FIG. 21, since topic specification information 810 (=“Sato”) is included in the received first morpheme information “Sato, like”, the topic retrieval unit 1370 specifies the topic specification information 810 (=“Sato”) and then compares the topic titles (820) 1-1, 1-2, . . . associated with the topic specification information 810 (=“Sato”) and the received first morpheme information “Sato, like”.

The topic retrieval unit 1370 retrieves the topic title (820) 1-1 (Sato; *; like) related to the received first morpheme information “Sato, like” among the topic titles (820) 1-1, 1-2, . . . based on the comparison result. The topic retrieval unit 1370 outputs the retrieved topic title (820) 1-1 (Sato; *; like) as a retrieval result signal to the reply retrieval unit 1380.

### [Reply Retrieval Unit]

The reply retrieval unit 1380 retrieves, based on the topic title 820 retrieved by the elliptical sentence complementation unit 1360 or the topic retrieval unit 1370, a reply sentence associated with the topic title 820. In addition, the reply retrieval unit 1380 compares, based on the topic title 820 retrieved by the topic retrieval unit 1370, the response types associated with the topic title 820 and the utterance type determined by the input type determining unit 1440. The reply retrieval unit 1380, which has executed the comparison, retrieves one response type related to the determined utterance type among the response types.

In the example shown in FIG. 21, when the topic title retrieved by the topic retrieval unit 1370 is the topic title 1-1 (Sato; *; like), the reply retrieval unit 1380 specifies the response type (for example, DA) coincident with the “uttered sentence type” (DA) determined by the input type determining unit 1440 among the reply sentences 1-1 (DA, TA and so on) associated with the topic title 1-1. The reply retrieval unit 1380, which has specified the response type (DA), retrieves the reply sentence 1-1 (“I like Sato, too.”) associated with the response type (DA) based on the specified response type (DA).

Here, “A” in above-mentioned “DA”, “TA” and so on means an affirmative form. Therefore, when the utterance types and the response types include “A”, it indicates an affirmation on a certain matter. In addition, the utterance types and the response types can include the types of “DQ”, “TQ” and so on. “Q” in “DQ”, “TQ” and so on means a question about a certain matter.

If the response type takes an interrogative form (Q), a reply sentence associated with this response type takes an affirmative form (A). A reply sentence with an affirmative form (A) may be a sentence for replying to a question and so on. For example, when an uttered sentence is “Have you ever operated slot machines?”, the utterance type of the uttered sentence is an interrogative form (Q). A reply sentence associated with this interrogative form (Q) may be “I have operated slot machines before,” (affirmative form (A)), for example.

On the other hand, when the response type is an affirmative form (A), a reply sentence associated with this response type takes an interrogative form (Q). A reply sentence in an interrogative form (Q) may be an interrogative sentence for asking back against uttered contents, an interrogative sentence for getting out a certain matter. For example, when the uttered sentence is “Playing slot machines is my hobby,” the utterance type of this uttered sentence takes an affirmative form (A). A reply sentence associated with this affirmative form (A) may be “Playing pachinko is your hobby, isn't it?” (an interrogative sentence (Q) for getting out a certain matter), for example.

The reply retrieval unit 1380 outputs the retrieved reply sentence 830 as a reply sentence signal to the managing unit 1310. The managing unit 1310, which has received the reply sentence signal from the reply retrieval unit 1380, outputs the received reply sentence signal to the output unit 1600.

### [CA Conversation Process Unit]

When a reply sentence in response to a user's utterance has not been determined by the plan conversation process unit 1320 or the discourse space conversation control process unit 1330, the CA conversation process unit 1340 functions to output a reply sentence for continuing a conversation with a user according to contents of the user's utterance.

The configuration example of the conversation controller 1000 is further described with referring back to FIG. 9.

### [Output Unit]

The output unit 1600 outputs the reply sentence retrieved by the reply retrieval unit 1380. The output unit 1600 may be a speaker or a display, for example. Specifically, the output unit 1600, which has received the reply sentence from the reply retrieval unit 1380, outputs voice sounds of the received reply sentence (for example, “I like Sato, too,”) based on the received reply sentence. With that, describing the configuration example of the conversation controller 1000 has ended.

### [Conversation Control Method]

The conversation controller 100 with the above-mentioned configuration puts a conversation control method in execution by operating as described hereinbelow.

Next, operations of the conversation controller 1000, more specifically the conversation control unit 1300, according to the present embodiment will be described.

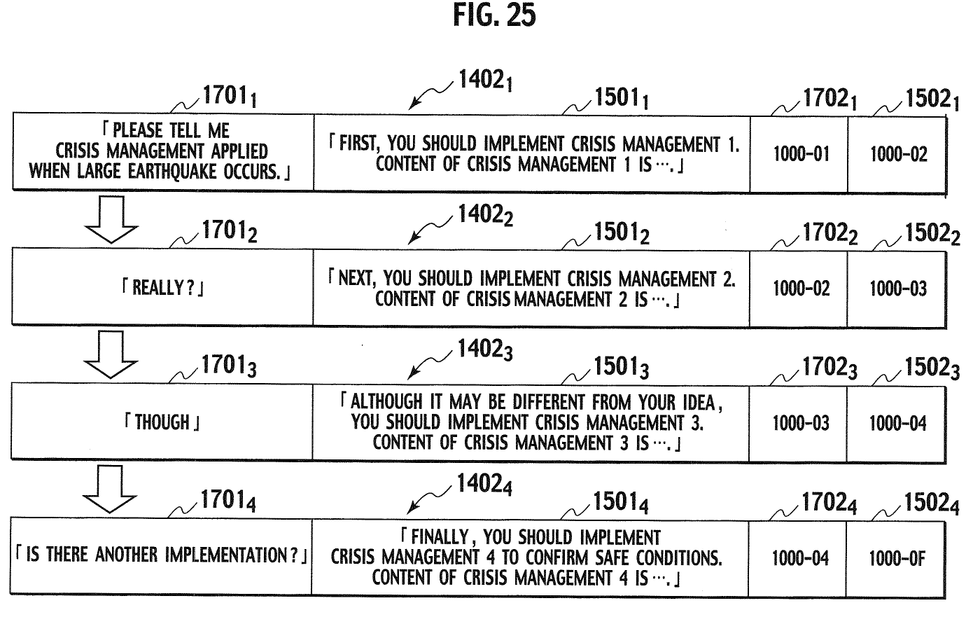

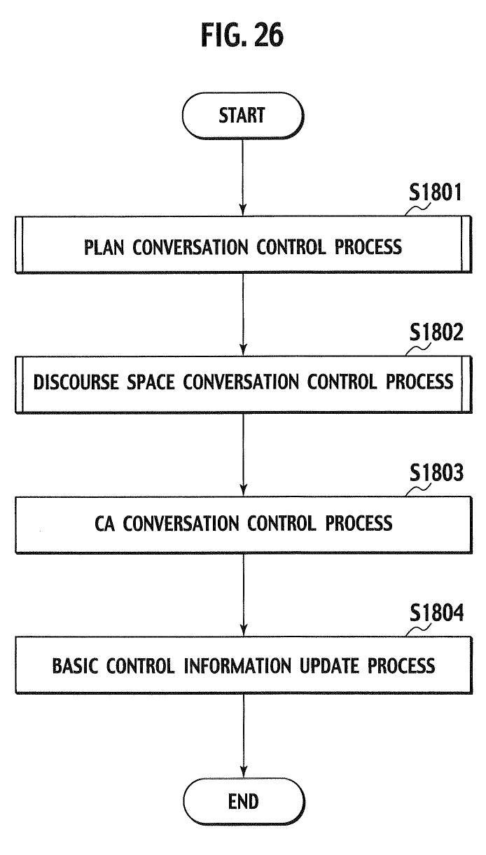

FIG. 26 is a flow-chart showing an example of a main process executed by conversation control unit 1300. This main process is a process executed each time when the conversation control unit 1300 receives a user's utterance. A reply sentence in response to the user's utterance is output due to an execution of this main process, so that a conversation (an interlocution) between a user and the conversation controller 100 is established.

Upon executing the main process, the conversation controller 100, more specifically the plan conversation process unit 1320 firstly executes a plan conversation control process (S1801). The plan conversation control process is a process for executing a plan(s).

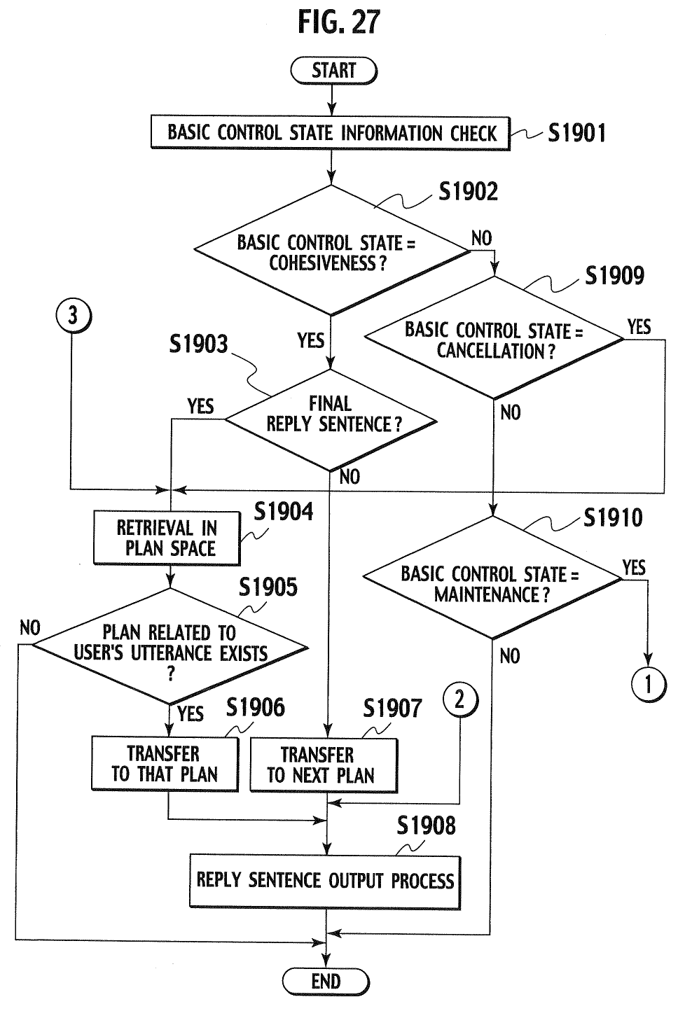

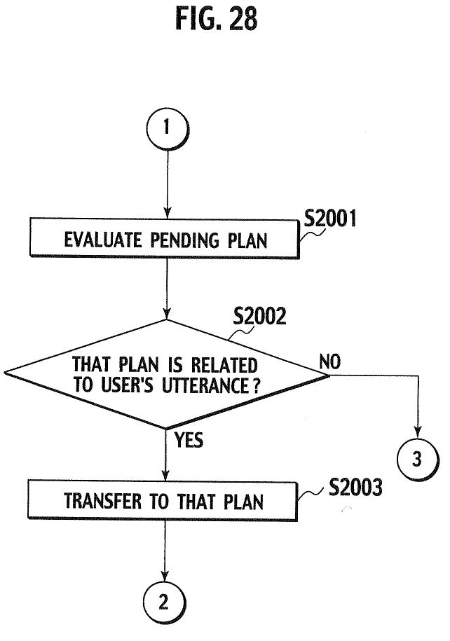

FIGS. 27 and 28 are flow-charts showing an example of the plan conversation control process. Hereinbelow, the example of the plan conversation control process will be described with reference to FIGS. 27 and 28.

Upon executing the plan conversation control process, the plan conversation process unit 1320 firstly executes a basic control state information check (S1901). The basic control state information is information on whether or not an execution(s) of a plan(s) has been completed and is stored in a predetermined memory area.

The basic control state information serves to indicate a basic control state of a plan.

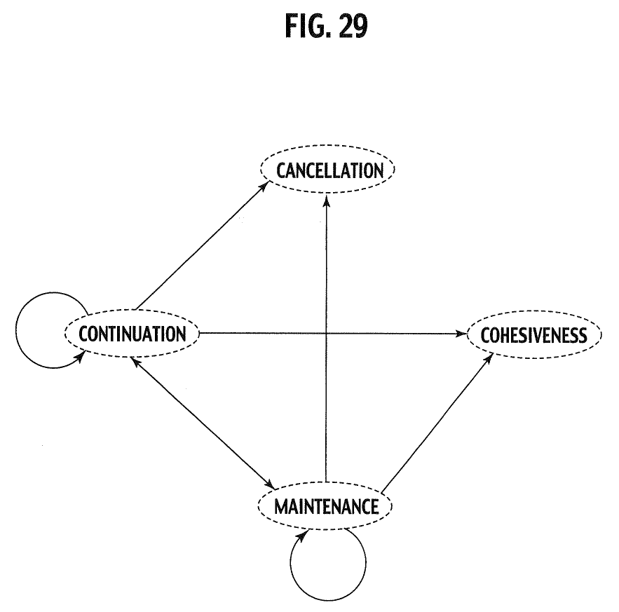

FIG. 29 is a diagram showing four basic control states which are possibly established due to a so-called scenario-type plan.

### (1) Cohesiveness

This basic control state corresponds to a case where a user's utterance is coincident with the currently executed plan 1402, more specifically the topic title 820 or the example sentence 1701 associated with the plan 1402. In this case, the plan conversation process unit 1320 terminates the plan 1402 and then transfers to another plan 1402 corresponding to the reply sentence 1501 designated by the next-plan designation information 1502.

### (2) Cancellation

This basic control state is a basic control state which is set in a case where it is determined that user's utterance contents require a completion of a plan 1402 or that a user's interest has changed to another matter than the currently executed plan. When the basic control state indicates the cancellation, the plan conversation process unit 1320 retrieves another plan 1402 associated with the user's utterance than the plan 1402 targeted as the cancellation. If the other plan 1402 exists, the plan conversation process unit 1320 start to execute the other plan 1402. If the other plan 1402 does not exist, the plan conversation process unit 1320 terminates a execution(s) of a plan(s).

### (3) Maintenance

This basic control state is a basic control state which is set in a case where a user's utterance is not coincident with the topic title 820 (see FIG. 21) or the example sentence 1701 (see FIG. 25) associated with the currently executed plan 1402 and also the user's utterance does not correspond to the basic control state “cancellation”.

In the case of this basic control state, the plan conversation process unit 1320 firstly determines whether or not to resume a pending or pausing plan 1402 on receiving the user's utterance. If the user's utterance is not adapted for resuming the plan 1402, for example, in case where the user's utterance is not related to a topic title 820 or an example sentence 1701 associated with the plan 1402, the plan conversation process unit 1320 starts to execute another plan 1402, an after-mentioned discourse space conversation control process (S1802) and so on. If the user's utterance is adapted for resuming the plan 1402, the plan conversation process unit 1320 outputs a reply sentence 1501 based on the stored next-plan designation information 1502.

In case where the basic control state is the “maintenance”, the plan conversation process unit 1320 retrieves other plans 1402 in order to enable outputting another reply sentence than the reply sentence 1501 associated with the currently executed plan 1402, or executes the discourse space conversation control process. However, if the user's utterance is adapted for resuming the plan 1402, the plan conversation process unit 1320 resumes the plan 1402.

### (4) Continuation

This state is a basic control state which is set in a case where a user's utterance is not related to reply sentences 1501 included in the currently executed plan 1402, contents of the user's utterance do not correspond to the basic control sate “cancellation” and use's intention construed from the user's utterance is not clear.

In case where the basic control state is the “continuation”, the plan conversation process unit 1320 firstly determines whether or not to resume a pending or pausing plan 1402 on receiving the user's utterance. If the user's utterance is not adapted for resuming the plan 1402, the plan conversation process unit 1320 executes an after-mentioned CA conversation control process in order to enable outputting a reply sentence for getting out a further user's utterance.

The plan conversation control process is further described with referring back to FIG. 27.

The plan conversation process unit 1320, which has referred to the basic control state, determines whether or not the basic control state indicated by the basic control state information is the “cohesiveness” (step S1902). If it has been determined that the basic control state is the “cohesiveness” (YES in step S1902), the plan conversation process unit 1320 determines whether or not the reply sentence 1501 is the final reply sentence in the currently executed plan 1402 (step S1903).

If it has been determined that the final reply sentence 1501 has been output already (YES in step S1903), the plan conversation process unit 1320 retrieves another plan 1402 related to the use's utterance in the plan space in order to determine whether or not to execute the other plan 1402 (step S1904) because the plan conversation process unit 1320 has provided all contents to be replied to the user already. If the other plan 1402 related to the user's utterance has not been found due to this retrieval (NO in step S1905), the plan conversation process unit 1320 terminates the plan conversation control process because no plan 1402 to be provided to the user exists.

On the other hand, if the other plan 1402 related to the user's utterance has been found due to this retrieval (YES in step S1905), the plan conversation process unit 1320 transfers into the other plan 1402 (step S1906). Since the other plan 1402 to be provided to the user still remains, an execution of the other plan 1402 (an output of the reply sentence 1501 included in the other plan 1402) is started.

Next, the plan conversation process unit 1320 outputs the reply sentence 1501 included in that plan 1402 (step S1908). The reply sentence 1501 is output as a reply to the user's utterance, so that the plan conversation process unit 1320 provides information to be supplied to the user.

The plan conversation process unit 1320 terminates the plan conversation control process after the reply sentence output process (step S1908).

On the other hand, if the previously output reply sentence 1501 is not determined as the final reply sentence in the determination whether or not the previously output reply sentence 1501 is the final reply sentence (step S1903), the plan conversation process unit 1320 transfers into a plan 1402 associated with the reply sentence 1501 following the previously output reply sentence 1501, i.e. the specified reply sentence 1501 by the next-plan designation information 1502 (step S1907).

Subsequently, the plan conversation process unit 1320 outputs the reply sentence 1501 included in that plan 1402 to provide a reply to the user's utterance (step 1908). The reply sentence 1501 is output as the reply to the user's utterance, so that the plan conversation process unit 1320 provides information to be supplied to the user. The plan conversation process unit 1320 terminates the plan conversation control process after the reply sentence output process (step S1908).

Here, if the basic control state is not the “cohesiveness” in the determination process in step S1902 (NO in step S1902), the plan conversation process unit 1320 determines whether or not the basic control state indicated by the basic control state information is the “cancellation”(step S1909). If it has been determined that the basic control state is the “cancellation” (YES in step S1909), the plan conversation process unit 1320 retrieves another plan 1402 related to the use's utterance in the plan space 1401 in order to determine whether or not the other plan 1402 to be started newly exists (step S1904) because a plan 1402 to be successively executed does not exist. Subsequently, the plan conversation process unit 1320 executes the processes of steps S1905 to S1908 as well as the processes in case of the above-mentioned step S1903 (YES).

On the other hand, if the basic control state is not the “cancellation” in the determination process in step S1902 (NO in step S1902) in the determination whether or not the basic control state indicated by the basic control state information is the “cancellation” (step S1909), the plan conversation process unit 1320 further determines whether or not the basic control state indicated by the basic control state information is the “maintenance” (step S1910).

If the basic control state indicated by the basic control state information is the “maintenance” (YES in step S1910), the plan conversation process unit 1320 determined whether or not the user presents the interest on the pending or pausing plan 1402 again and then resumes the pending or pausing plan 1402 in case where the interest is presented (step S2001 in FIG. 28). In other words, the plan conversation process unit 1320 evaluates the pending or pausing plan 1402 (step S2001 in FIG. 28) and then determines whether or not the user's utterance is related to the pending or pausing plan 1402 (step S2002).

If it has been determined that the user's utterance is related to that plan 1402 (YES in step S2002), the plan conversation process unit 1320 transfers into the plan 1402 related to the user's utterance (step S2003) and then executes the reply sentence output process (step S1908 in FIG. 27) to output the reply sentence 1501 included in the plan 1402. Operating in this manner, the plan conversation process unit 1320 can resume the pending or pausing plan 1402 according to the user's utterance, so that all contents included in the previously prepared plan 1402 can be provided to the user.

On the other hand, if it has been determined that the user's utterance is not related to that plan 1402 (NO in step S2002) in the above-mentioned S2002 (see FIG. 28), the plan conversation process unit 1320 retrieves another plan 1402 related to the use's utterance in the plan space 1401 in order to determine whether or not the other plan 1402 to be started newly exists (step S1904 in FIG. 27). Subsequently, the plan conversation process unit 1320 executes the processes of steps S1905 to S1908 as well as the processes in case of the above-mentioned step S1903 (YES).

If it is determined that the basic control state indicated by the basic control state information is not the “maintenance” (NO in step S1910) in the determination in step S1910, it means that the basic control state indicated by the basic control state information is the “continuation”. In this case, the plan conversation process unit 1320 terminates the plan conversation control process without outputting a reply sentence. With that, describing the plan control process has ended.

The main process is further described with referring back to FIG. 26.

The conversation control unit 1300 executes the discourse space conversation control process (step S1802) after the plan conversation control process (step S1801) has been completed. Note that, if the reply sentence has been output in the plan conversation control process (step S1801), the conversation control unit 1300 executes a basic control information update process (step S1804) without executing the discourse space conversation control process (step S1802) and the after-mentioned CA conversation control process (step S1803) and then terminates the main process.

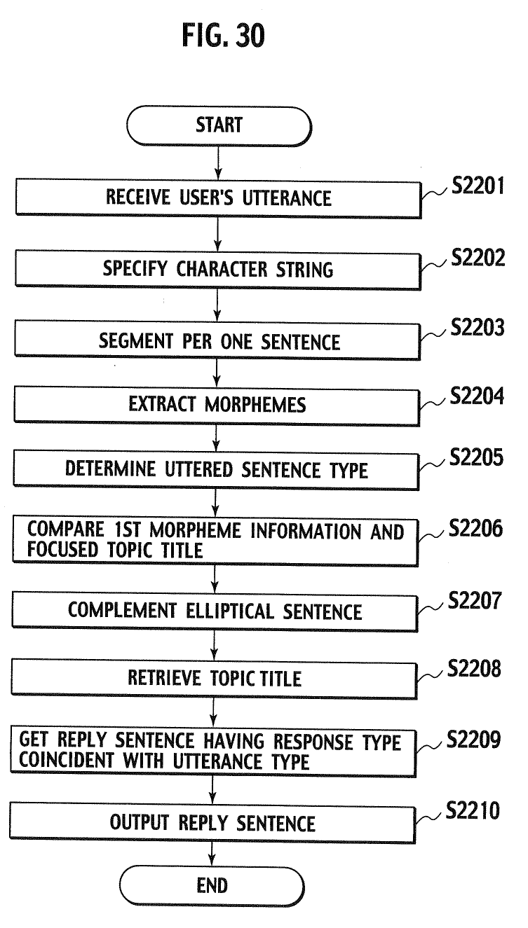

FIG. 30 is a flow-chart showing an example of a discourse space conversation control process according to the present embodiment.

The input unit 1100 firstly executes a step for receiving a user's utterance (step S2201). Specifically, the input unit 1100 receives voice sounds of the user's utterance. The input unit 1100 outputs the received voice sounds to the speech recognition unit 1200 as a voice signal. Note that the input unit 1100 may receive a character string input by a user (for example, text data input in a text format) instead of the voice sounds. In this case, the input unit 1100 may be a text input device such as a keyboard or a touchscreen.

Next, the speech recognition unit 1200 executes a step for specifying a character string corresponding to the uttered contents based on the uttered contents retrieved by the input unit 1100 (step S2202). Specifically, the speech recognition unit 1200, which has received the voice signal from the input unit 1100, specifies a word hypothesis (candidate) corresponding to the voice signal based on the received voice signal. The speech recognition unit 1200 retrieves a character string corresponding to the specified word hypothesis and outputs the retrieved character string to the conversation control unit 1300, more specifically the discourse space conversation control process unit 1330, as a character string signal.

And then, the character string specifying unit 1410 segments a series of the character strings specified by the speech recognition unit 1200 into segments (step S2203). Specifically, if the series of the character strings have a time interval more than a certain interval, the character string specifying unit 1410, which has received the character string signal or a morpheme signal from the managing unit 1310, segments the character strings there. The character string specifying unit 1410 outputs the segmented character strings to the morpheme extracting unit 1420 and the input type determining unit 1440. Note that it is preferred that the character string specifying unit 1410 segments a character string at a punctuation, a space and so on in a case where the character string has been input from a keyboard.

Subsequently, the morpheme extracting unit 1420 executes a step for extracting morphemes constituting minimum units of the character string as first morpheme information based on the character string specified by the character string specifying unit 1410 (step S2204). Specifically, the morpheme extracting unit 1420, which has received the character strings from the character string specifying unit 1410, compares the received character strings and morpheme groups previously stored in the morpheme database 1430. Note that, in the present embodiment, each of the morpheme groups is prepared as a morpheme dictionary in which a direction word, a reading, a word class and an inflected forms are described for each morpheme belonging to each word-class classification.

The morpheme extracting unit 1420, which has executed the comparison, extracts coincident morphemes (m1, m2, . . . ) with the morphemes included in the previously stored morpheme groups from the received character string. The morpheme extracting unit 1420 outputs the extracted morphemes to the topic specification information retrieval unit 1350 as the first morpheme information.

Next, the input type determining unit 1440 executes a step for determining the “uttered sentence type” based on the morphemes which constitute one sentence and are specified by the character string specifying unit 1410 (step S2205). Specifically, the input type determining unit 1440, which has received the character strings from the character string specifying unit 1410, compares the received character strings and the dictionaries stored in the utterance type database 1450 based on the received character strings and extracts elements relevant to the dictionaries among the character strings. The input type determining unit 1440, which has extracted the elements, determines to which “uttered sentence type” the extracted element(s) belongs based on the extracted element(s). The input type determining unit 1440 outputs the determined “uttered sentence type” (utterance type) to the reply retrieval unit 1380.

And then, the topic specification information retrieval unit 1350 executes a step for comparing the first morpheme information extracted by the morpheme extracting unit 1420 and the focused topic title 820focus (step S2206).

If a morpheme in the first morpheme information is related to the focused topic title 820focus, the topic specification information retrieval unit 1350 outputs the focused topic title 820focus to the reply retrieval unit 1380. On the other hand, if no morpheme in the first morpheme information is related to the focused topic title 820focus, the topic specification information retrieval unit 1350 outputs the received first morpheme information and the user input sentence topic specification information to the elliptical sentence complementation unit 1360 as the retrieval command signal.

Subsequently, the elliptical sentence complementation unit 1360 executes a step for including the focused topic specification information and the reply sentence topic specification information into the received first morpheme information based on the first morpheme information received from the topic specification information retrieval unit 1350 (step S2207). Specifically, if it is assumed that the first morpheme information is defined as “W” and a set of the focused topic specification information and the reply sentence topic specification information is defined as “D”, the elliptical sentence complementation unit 1360 generates the complemented first morpheme information by including an element(s) in the set “D” into the first morpheme information “W” and compares the complemented first morpheme information and all the topic titles 820 to retrieve the topic title 820 related to the complemented first morpheme information. If the topic title 820 related to the complemented first morpheme information has been found, the elliptical sentence complementation unit 1360 outputs the topic title 820 to the reply retrieval unit 1380. On the other hand, if no topic title 820 related to the complemented first morpheme information has been found, the elliptical sentence complementation unit 1360 outputs the first morpheme information and the user input sentence topic specification information to the topic retrieval unit 1370.

Next, the topic retrieval unit 1370 executes a step for comparing the first morpheme information and the user input sentence topic specification information and retrieves the topic title 820 best-suited for the first morpheme information among the topic titles 820 (step S2208). Specifically, the topic retrieval unit 1370, which has received the retrieval command signal from the elliptical sentence complementation unit 1360, retrieves the topic title 820 best-suited for the first morpheme information among topic titles 820 associated with the user input sentence topic specification information based on the user input sentence topic specification information and the first morpheme information included in the received retrieval command signal. The topic retrieval unit 1370 outputs the retrieved topic title 820 to the reply retrieval unit 1380 as the retrieval result signal.

Next, the reply retrieval unit 1380 compares, in order to select the reply sentence 830, the user's utterance type determined by the sentence analyzing unit 1400 and the response type associated with the retrieved topic title 820 based on the retrieved topic title 820 by the topic specification information retrieval unit 1350, the elliptical sentence complementation unit 1360 or the topic retrieval unit 1370 (step S2209).

The reply sentence 830 is selected in particular as explained hereinbelow. Specifically, based on the “topic title” associated with the received retrieval result signal and the received “uttered sentence type”, the reply retrieval unit 1380, which has received the retrieval result signal from the topic retrieval unit 1370 and the “uttered sentence type” from the input type determining unit 1440, specifies one response type coincident with the “uttered sentence type” (for example, DA) among the response types associated with the “topic title”.

Consequently, the reply retrieval unit 1380 outputs the reply sentence 830 retrieved in step S2209 to the output unit 1600 via the managing unit 1310 (S2210). The output unit 1600, which has received the reply sentence 830 from the managing unit 1310, outputs the received reply sentence 830.

With that, describing the discourse space conversation control process has ended and the main process is further described with referring back to FIG. 26.

The conversation control unit 1300 executes the CA conversation control process (step S1803) after the discourse space conversation control process has been completed. Note that, if the reply sentence has been output in the plan conversation control process (step S1801) or the discourse space conversation control (S1802), the conversation control unit 1300 executes the basic control information update process (step S1804) without executing the CA conversation control process (step S1803) and then terminates the main process.

The CA conversation control process is a process in which it is determined whether a user's utterance is an utterance for “explaining something”, an utterance for “confirming something”, an utterance for “accusing or rebuking something” or an utterance for “other than these”, and then a reply sentence is output according to the user's utterance contents and the determination result.

By the CA conversation control process, a so-called “bridging” reply sentence for continuing the uninterrupted conversation with the user can be output even if a reply sentence suited for the user's utterance can not be output by the plan conversation control process nor the discourse space conversation control process.

Next, the conversation control unit 1300 executes the basic control information update process (step S1804). In this process, the conversation control unit 1300, more specifically the managing unit 1310, sets the basic control information to the “cohesiveness” when the plan conversation process unit 1320 has output a reply sentence, sets the basic control information to the “cancellation” when the plan conversation process unit 1320 has cancelled an output of a reply sentence, sets the basic control information to the “maintenance” when the discourse space conversation control process unit 1330 has output a reply sentence, or sets the basic control information to the “continuation” when the CA conversation process unit 1340 has output a reply sentence.

The basic control information set in this basic control information update process is referred in the above-mentioned plan conversation control process (step S1801) to be employed for continuation or resumption of a plan.

As described the above, the conversation controller 1000 can executes a previously prepared plan(s) or can adequately respond to a topic(s) which is not included in a plan(s) according to a user's utterance by executing the main process each time when receiving the user's utterance.

In the gaming terminal 4 of this embodiment, the above-described input unit 1100 of the conversation controller 1000 can be formed of the display 8 (the touch panel 50 fitted thereto) and the microphone 15. Meanwhile, the output unit 1600 can be formed of the display 8 and the speaker 10. Further, the speech recognition unit 1200, the conversation control unit 1300, and the character string specifying unit 1410, the morpheme extracting unit 1420 and the input type determining unit 1440 each of which is in the sentence analyzing unit 1400 can be formed of the terminal controller 90. Meanwhile, both of the morpheme database 1430 and the utterance type database 1450 in the sentence analyzing unit 1400, the conversation database 1500, and the speech recognition dictionary memory 1700 can be formed of the external memory 99.

Moreover, in this embodiment, it is possible to determine the language used in the course of the roulette games through the dialog with the player by using the conversation engine, which utilize the conversation controller 1000 achieved in the gaming terminal 4 with the above-described configuration.

Accordingly, in order to recognize the type of the language used in the speech message of the player inputted from the microphone 15, the speech recognition dictionary memory 1700 of the conversation controller 1000 formed of the external memory 99 includes word dictionaries in several languages. Meanwhile, the morpheme database 1430 of the conversation controller 1000 formed of the external memory 99 includes morpheme groups (morpheme dictionaries) in several languages. Further, the utterance type database 1450 of the conversation controller 1000 formed of the external memory 99 also includes dictionaries for the respective utterance types in several languages.

Meanwhile, in order to output the speech messages from the speaker 10 to the player in the language selected by the player and to display the messages on the display 8 in the language selected by the player, the conversation database 1500 formed by the terminal controller 90 also stores data of “sentences” in several languages. The “sentences” includes a message for requesting to input a specific word or a specific sentence (either orally or by means of an operation using the display 8) in the language desired to be used in the roulette games, a message for asking the player to confirm that the language used for inputting the specific work or the specific sentence is also used to execute the roulette games.

Here, instead of providing the speech recognition dictionary memory 1700, the morpheme database 1430, and the utterance type database 1450 of the conversation controller 1000 with the word dictionaries in several languages or instead of storing the “sentence” data in several languages in the conversation database 1500, it is also possible to provide the single gaming terminal 4 with several conversation controllers 1000 corresponding to the respective languages controllable with the gaming terminal 4.

Operations of the above-mentioned conversation controller 1000 in the gaming terminal 4 of this embodiment will be described later.

Subsequently, contents of the gaming processes to be respectively executed by the server 13, the roulette device 2, and the gaming terminal 4 of the roulette game machine 1 according to this embodiment will be described below.

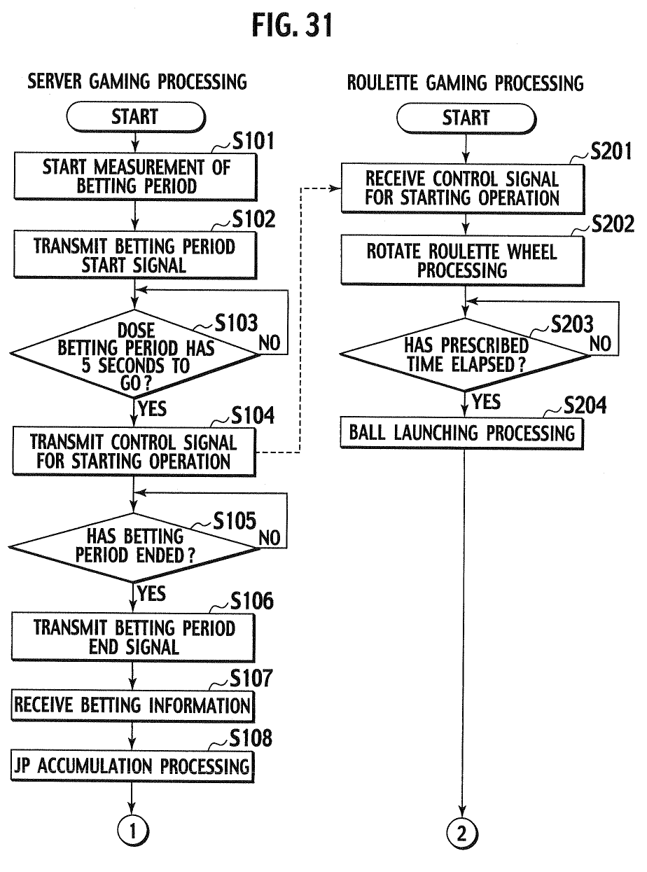

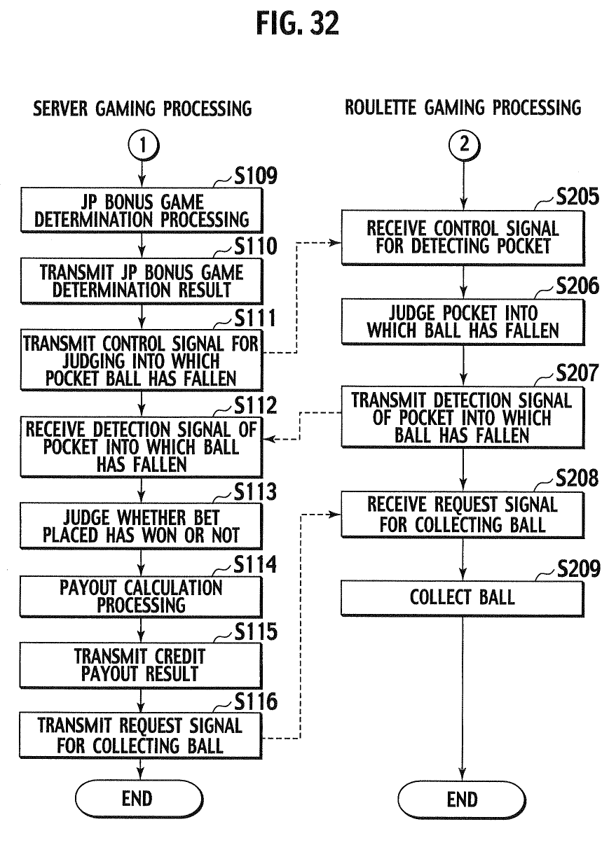

With reference to FIGS. 31 and 32, descriptions will be provided for a server gaming processing and a roulette gaming processing. Here, the server gaming processing is executed by the server CPU 81 of the server 13 in accordance with programs stored in the ROM 82, and the roulette gaming processing is executed by the CPU 101 of the roulette device 2 in accordance with programs stored in the ROM 102. FIGS. 31 and 32 are flow charts showing the gaming processings of the server 13 and the roulette device 2 in the roulette game machine 1 according to the present embodiment.

Firstly, the gaming processing of the server 13 will be described referring to FIGS. 31 and 32.

As shown in FIG. 31, the server CPU 81 starts the measurement of the betting period first (step S101). The betting period is a period when the bet can be placed. The player participating in the game can place a bet on the bet area 72 predicted by himself, by operating the touch panel 50 during the betting period. When the measurement of the betting period is started, the server CPU 81 transmits a betting period start signal to the terminal CPU 91 (step S102).

Next, the server CPU 81 judges whether the remaining betting period has become 5 seconds or less (step S103). The remaining betting period is displayed on the bet time display unit 69 of the display 8 at each of the gaming terminals 4 (see FIG. 5). In the case where it is judged that it has not reached the last 5 seconds, the processing will be returned to the step S103. On the other hand, in the case where it is judged that it has reached the last 5 seconds, the processing will move to the step S104.

The server CPU 81 transmits the control signal for starting the operation of the roulette device 2 to the CPU 101 (step S104). After that, the server CPU 81 judges whether the betting period of the roulette game has ended or not (step S105). In the case where it is judged that the betting period has not ended, the server CPU 81 suspends the processing until the betting period ends. On the other hand, in the case where it is judged that the betting period of the roulette game has ended, the server CPU 81 transmits a betting period end signal to the terminal CPU 91 (step S106).

Subsequently, the server CPU 81 receives the betting information (the specified bet area 72, the number of bet chips, and the type of betting) at each gaming terminal 4 from the terminal CPU 91, and stores it into the betting information memory area 83A of the RAM 83 (step S107).

After that, the server CPU 81 executes a JP accumulation processing (step S108). In this JP accumulation processing, 0.30% of the total credits which have been bet at all the gaming terminals 4 that are received at the step S107 are accumulatively added to the JP credits stored in the “MINI” JP accumulated memory area 83C in the RAM 83. Moreover, in the JP accumulation processing, 0.20% of the total credits are accumulatively added to the JP credits stored in the “MAJOR” JP credit memory area 83D in the RAM 83. In addition, in the JP accumulation processing, 0.15% of the total credits are accumulatively added to the JP credits stored in the “MEGA” JP credit memory area 83E in the RAM 83. Furthermore, in the JP accumulation processing, the displays on the JP amount display 15, the MEGA counter 73, the MAJOR counter 74 and the MINI counter 75 are updated according to the JP credits thus accumulatively added.

Next, as shown in FIG. 32, the server CPU 81 executes a JP bonus game determination processing (step S109). In this processing, the server CPU 81 determines whether to execute the JP bonus game at each gaming terminal 4 or not, by using a random number value sampled by a sampling circuit or the like. In addition, the server CPU 81 determines which gaming terminal 4 is to win the JP (or all the gaming terminals 4 are to lose) in the case where it is determined to execute the JP bonus game. Also, the server CPU 81 determines which JP (“MEGA”, “MAJOR” or “MINI”) is to be won in the case of having the JP won.

Next, the server CPU 81 transmits the JP bonus game determination result to each gaming terminal 4, according to the processing of the step S109 (step S110). After that, the server CPU 81 transmits a control signal to the CPU 101 of the roulette device 2, and thereby causes the CPU 101 to judge into which number pocket 23 the ball 27 has fallen (step S111). Then, the server CPU 81 receives a detection signal of the number pocket 23 into which the ball 27 has fallen from the CPU 101 (step S112).

Thereafter, the server CPU 81 judges whether the bet placed at each gaming terminal 4 has won or not, based on the betting information of each gaming terminal 4 received at the step S107 and the detection signal of the number pocket 23 received at the step S112 (step S113).

After that, the server CPU 81 executes the payout calculation processing (step S114). In the payout calculation processing, the server CPU 81 firstly recognizes the number of winning bets on the winning number for each gaming terminal 4. Then, the server CPU 81 calculates the total payout credits for each gaming terminal 4 by using the payout rate (credits to be paid per one bet) that is stored in the payout memory area 82A of the ROM 82.

Next, the server CPU 81 executes the transmission processing of the credit payout result according to the payout calculation processing of the step S113 and the JP payout result according to the JP bonus game determination processing of the step S109 (step S115). More specifically, the server CPU 81 outputs the credit data corresponding to the payout credits for the game to the terminal CPU 91 of the winning gaming terminal 4. Moreover, the server CPU 81 additionally outputs the credit data corresponding to the accumulated JP credits in the case where the JP has been won. After that, the server CPU 81 transmits a request signal for collecting the ball 27 on the roulette wheel 22 to the CPU 101 of the roulette device 2 (step S116). The server CPU 81 finishes the subroutine after the step S116.

Hereinafter, the gaming processing of the roulette device 2 will be described with references to FIGS. 31 and 32.

Firstly, as shown in FIG. 31, the CPU 101 receives the control signal for starting the operation of the roulette device 2 from the server CPU 81 of the server 13 (step S201).

Next, the CPU 101 drives the wheel driving motor 106 and rotates the roulette wheel 22 (step S202).

Then, the CPU 101 detects the detection signal from the pocket position detection circuit 107 when a prescribed time (20 seconds, for example) elapses after the rotation of the roulette wheel 22 is started (step S203: YES). The CPU 101 enters the ball 27 (step S204) when the delay time elapses after the detection signal is detected.

Then, as shown in FIG. 32, the CPU 101 receives the control signal for detecting the pocket from the server CPU 81 of the server 13 (step S205). Thereafter, the CPU 101 judges which number pocket 23 into which the ball 27 has fallen by activating the ball sensor 105 (step S206). After that, the CPU 101 transmits the detection signal indicating the number pocket 23 into which the ball 27 has fallen to the server CPU 81 of the server 13 (step S207).

Subsequently, the CPU 101 receives the request signal for collecting the ball 27 from the server CPU 81 of the server 13 (step S208). Then, the CPU 101 collects the ball 27 on the roulette wheel 22 by activating the ball collecting device 108 provided beneath the roulette wheel 22 (step S209). The collected ball 27 will be entered onto the roulette wheel 22 again by the ball launching device 104 in the subsequent games. The CPU 101 finishes the subroutine after the step S209.

Hereinbelow, the processing executed by the terminal CPU 91 of each gaming terminal 4 of the roulette game machine 1 according to the present embodiment will be described with reference to FIGS. 33 to 37. The terminal CPU 91 executes the processing in accordance with the programs stored in the ROM 92. FIGS. 33 to 37 are flow charts each showing the gaming processing of the gaming terminal of the roulette game machine according to the present embodiment.

Here, the flag F in the RAM 93 is assumed to be set to be default, “1”, which is a value indicating the betting period. Moreover, the default BET screen 61 as shown in FIG. 5 is assumed to be displayed on the display 8 of the gaming terminal 4. With this state, as shown in FIG. 33, the terminal CPU 91 firstly performs used language confirmation processing in step S300, then performs betting period confirmation processing in step S301, then performs bet accepting processing in step S302, and lastly performs payout amount output processing in step S303.

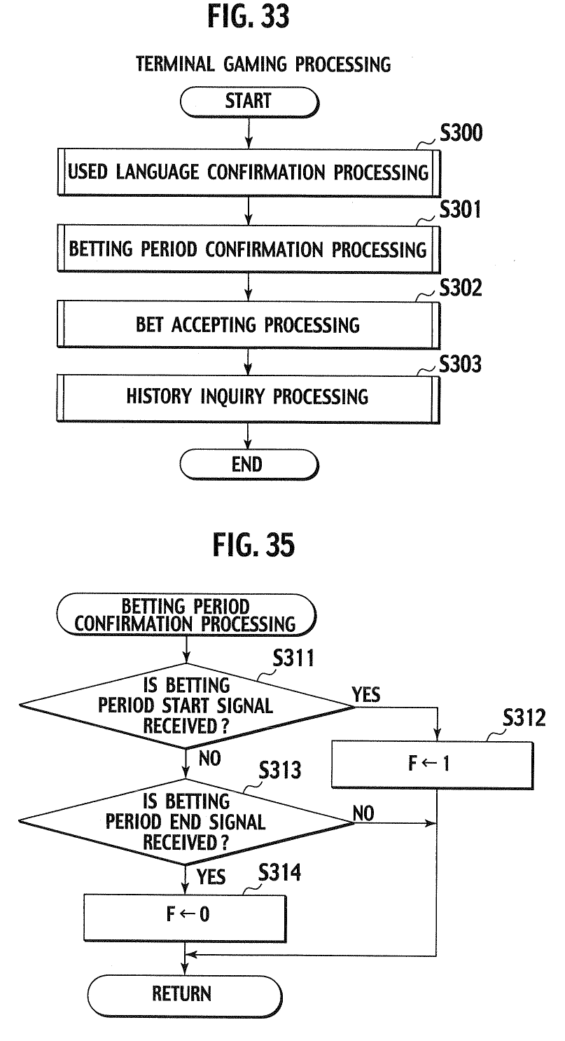

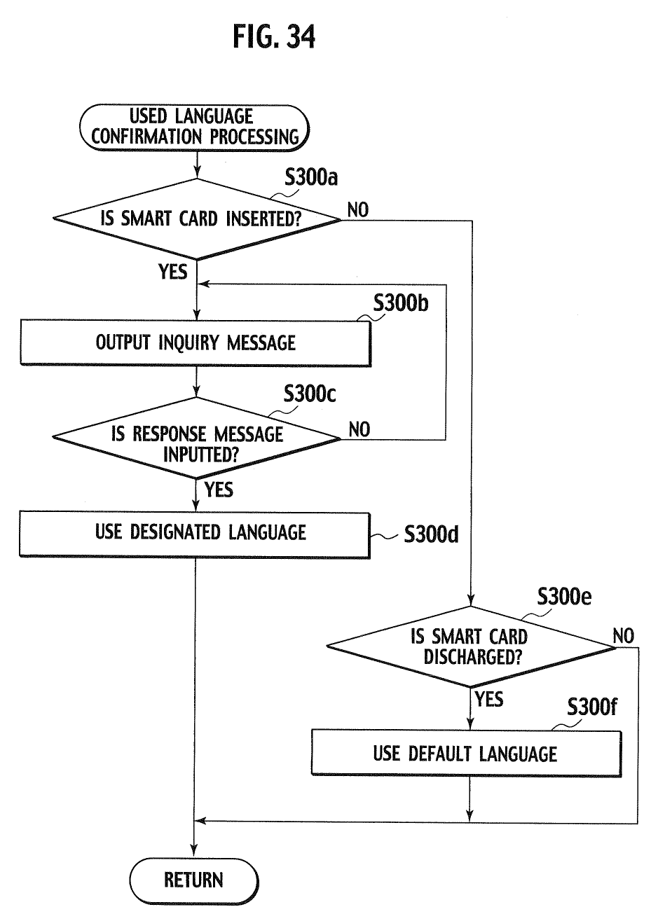

Then, in the used language confirmation processing in step S300, the terminal CPU 91 judges whether or not the new smart card 17 is inserted to the card reader 16 in step S300a as shown in FIG. 34. If the smart card 17 is not inserted (NO in step S300a), the terminal CPI 91 shifts the processing to step S300e to be described later. When the smart card 17 is inserted (YES in step S300a), the terminal CPU 91 outputs the message (the conversation sentence), to the player, to inquire what language to use in the roulette game (step S300b).

This message may be outputted in the sound from the speaker 10 through the sound input circuit 98 or outputted in the form of display of characters or the like on the display 8 through the LCD driving circuit 95.

For example, when outputting the message in the sound, the terminal CPU 91 outputs the sound for requesting selection of the language to be used in the game from the speaker 10 by using a default language type. When the default language type is English, for instance, the terminal CPU 91 outputs the sound stating “What language do you want to use?” from the speaker 10.

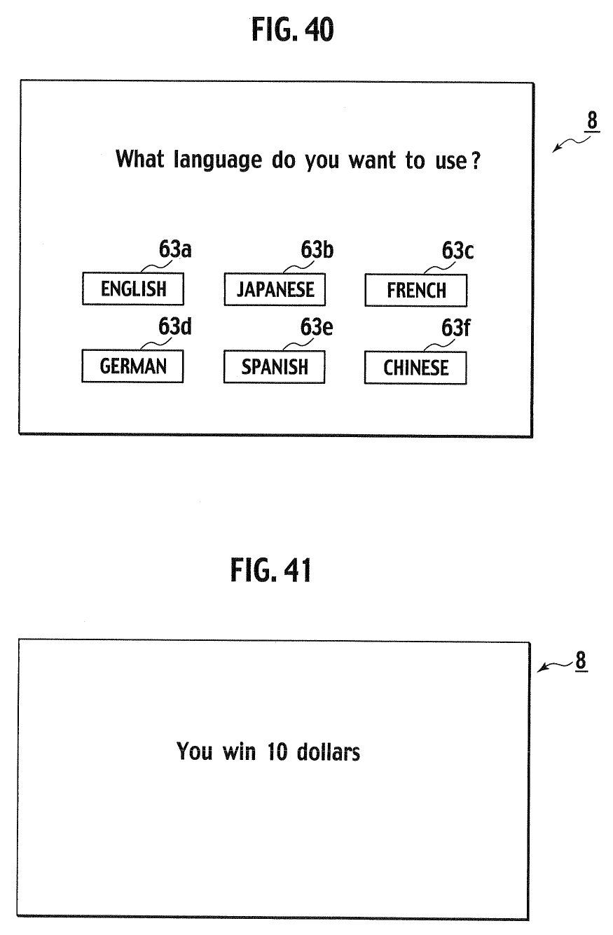

Meanwhile, when outputting the message in the form of display, the terminal CPU 91 displays, by using the default language type, characters, buttons, and the like on the display 8 in order to allow the player to select the language to be used in the game. For example, when the default language type is English, the terminal CPU 91 displays characters stating “What language do you want to use?” together with buttons 63a, 63b, 63c, 63d, 63e, and 63f representing language options of “English”, “Japanese”, “French”, “German”, “Spanish”, and “Chinese” as shown in FIG. 40.

Thereafter, the terminal CPU 91 judges whether or not a response message (a response sentence) to the message outputted in step S300b is inputted (step S300c).

Here, when the message outputted in step S300b is in the sound, the presence of the input of the message in response to the outputted message can be confirmed by judging whether or not there is the input to the input unit 1100 of the conversation controller 1000 after outputting the message in step S300b. Meanwhile, when the outputted message in step S300b is displayed on the display 8, the presence of the input of the message in response to the outputted message can be confirmed by judging whether or not an operation of any of language selection buttons displayed on the display 8 (the buttons 63a, 63b, 63c, 63d, 63e, and 63f stating “English”, “Japanese”, “French”, “German”, “Spanish”, and “Chinese” shown in FIG. 40) respectively by the player is detected with the touch panel 50.

Then, if no response message to the message outputted in step S300b is inputted (NO in step S300c), the terminal CPU 91 repeats step S300c until there is the input. When the response message is inputted (YES in step S300c), the terminal CPU 91 changes the language of the BET screen 61 to be displayed on the display 8 during the betting period of the roulette game in the language indicated by the message inputted in step S300c (step S300d). Thereafter, the terminal CPU 91 terminates the used language confirmation processing.

Here, when the message inputted in step S300c is in the sound, the language indicated in the inputted message can be specified by analyzing the contents of the message inputted in the voice from the microphone 15 in accordance with the previously explained operations of the conversation controller 1000. Meanwhile, when the inputted message in step S300c is displayed on the display 8, the language indicated in the inputted message can be confirmed by allowing the terminal CPU 91 to identify contents of an operation of any of the buttons for language selection displayed on the display 8 by the player through the touch panel 50.

In step S300e, the terminal CPU 91 checks whether or not the smart card 17 is discharged from the card reader 16. If the smart card 17 is not discharged (NO in step S300e), the terminal CPU 91 terminates the used language confirmation processing. When the smart card 17 is discharged (YES in step S300e), the terminal CPU 91 displays, in the default language, the BET screen 61 to be displayed on the display 8 during the betting period of the roulette game (step S300f). Thereafter, the terminal CPU 91 terminates the used language confirmation processing. Here, the default language type may be defined as English, for example.

In the betting period confirmation processing (step S301), as shown in FIG. 35, the terminal CPU 91 confirms whether the betting period start signal has been received from the server CPU 81 or not (step S311). In the case where the betting period start signal has been received (step S311: YES), the terminal CPU 91 sets the flag F in the RAM 93 which indicates that it is under the betting period to “1” (step S312), and then terminates the betting period confirmation processing.

On the other hand, in the case where the betting time start signal has not been received yet (step S311: NO), the terminal CPU 91 confirms whether the betting period end signal has been received from the server CPU 81 or not (step S313). In the case where the betting period end signal has been received (step S313: YES), the terminal CPU 91 sets the flag F in the RAM 93 which indicates that it is under the betting period to “0” which indicates that it is not under the betting period (step S314), and then terminates the betting period confirmation processing. In the case where the betting period end signal has not been received yet (step S313: NO), the terminal CPU 91 terminates the betting period confirmation processing.

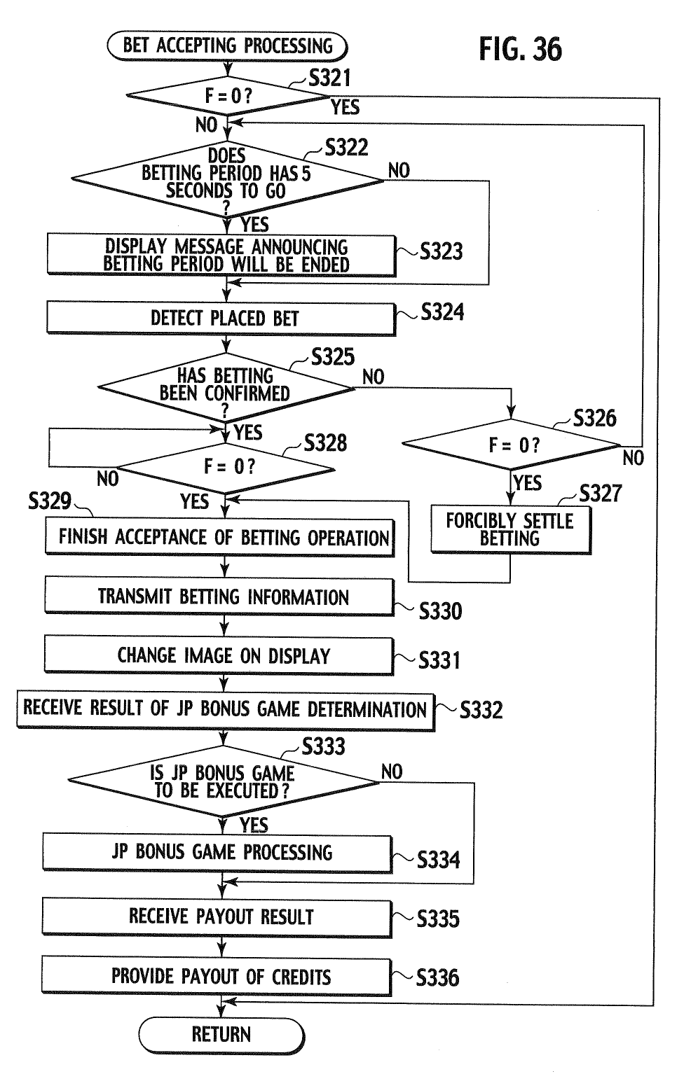

Then, in the bet accepting processing (step S302 in FIG. 33), as shown in FIG. 36, the terminal CPU 91 judges whether the flag F in the RAM 93 is set to “0” or not (step S321). In the case where the flag F is set to “0” (step S321: YES), the terminal CPU 91 terminates the bet accepting processing.

On the other hand, in the case where the flag F is not set to “0” (step S321: NO), the terminal CPU 91 judges whether the remaining betting time has reached the last 5 seconds (“5” or a smaller number is displayed on the bet time display unit 69) or not (step S322). In the case where the remaining time has reached the last 5 seconds (step S322: YES), the terminal CPU 91 displays a message announcing that the betting time will be ended on the bet screen 61 (step S323), and shifts the processing to the step S324. On the other hand, in the case where the remaining time has not reached the last 5 seconds (step S322: NO), the terminal CPU 91 shifts the processing to the step S324.

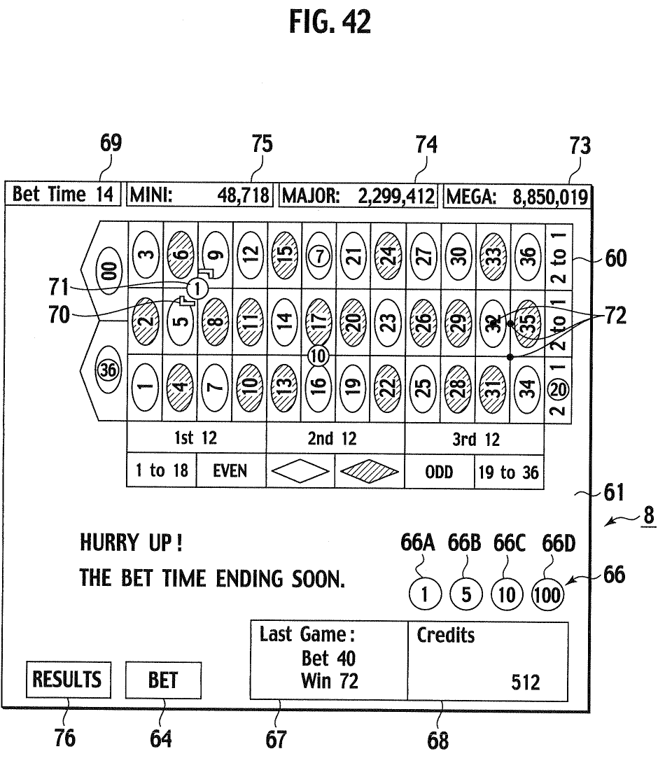

Here, when the BET screen 61 displayed on the display 8 is written in English as shown in FIG. 5, the message of the advance notice for the end of the betting period is shown in the contents such as “HURRY UP! THE BET TIME ENDING SOON.” as shown in FIG. 42, for example.

The terminal CPU 91 detects the bet placed by the player (step S324). The betting is detected by detecting the player's touches on the bet area 72 in the table-type betting board 60 and on the bet buttons 66 via the touch panel 50. When the betting is detected, the chip mark 71 is displayed on the specified bet area 72 on the display 8 according to the number of bet chips.

After that, the terminal CPU 91 judges whether the player has confirmed the betting or not (step S325). The betting is confirmed when the player's touch on the bet confirmation button 65 on the display 8 is detected via the touch panel 50.

In the case where it is judged that the betting has not been confirmed (step S325: NO), the terminal CPU 91 judges whether the flag F in the RAM 93 is set to “0” or not (step S326). In the case where the flag F is not set to “0” (step S326: NO), the terminal CPU 91 returns the processing to the step S322.

On the contrary, when the flag F is set to “0” (YES in step S326), the terminal CPU 91 forcibly settles the bet of chips by the player (step S327) and then shifts the processing to step S329 to be described later.

Meanwhile, when the bet of chips by the player is confirmed to be settled in step S325 (YES), the terminal CPU 91 judges whether or not the flag F of the RAM 93 is set to “0” in step S328. When the flag F is not set to “0” (NO in step S328), the terminal CPU 91 repeats step S326. On the contrary, when the flag F of the RAM 93 is set to “0” (YES in step S328), the terminal CPU 91 shifts the processing to step S329.

In the step S328, the terminal CPU 91 finishes accepting betting operations via the touch panel 50 (step S329). Thereafter, the terminal CPU 91 transmits the betting information of the player (the specified bet area 72, the number of bet chips and the types of betting) to the server CPU 81 (step S330).

Next, the terminal CPU 91 changes the image on the display 8 (step S331). To be more precise, the terminal CPU 91 firstly switches the image on the display 8 to the bet screen 61 including the image indicating that the betting period has ended.

Thereafter, the terminal CPU 91 receives the result of the JP bonus game determination processing from the server CPU 81 (step S332). The result of the JP bonus game determination includes the information which indicates: whether to execute the JP bonus game at any gaming terminal 4 or not; which gaming terminal 4 is to win the JP (or all the gaming terminals 4 are to lose) in the case where it is determined to execute the JP bonus game; and which JP (“MEGA”, “MAJOR” or “MINI”) is to be won in the case of having the JP won.

After that, the terminal CPU 91 determines whether to execute the JP bonus game or not, according to the result of the JP bonus game determination processing received at the step S332 (step S333). In the case where it is determined to execute the JP bonus game at its own gaming terminal 4, the terminal CPU 91 executes a prescribed selection-type JP bonus game. And then, the terminal CPU 91 displays the bonus game result (whether the JP has been won or not) in the bet screen 61 on the display 8 (step S334), according to the determination result received at the step S332.

In the case where it is determined not to execute the JP bonus game at its own gaming terminal 4 at the step S333, or after the step S334, the terminal CPU 91 receives the payout result from the server CPU 81 (step S335). Note that the payout result includes the payout for the roulette game and the payout for the JP bonus game.

Subsequently, the terminal CPU 91 provides a payout according to the payout result received at the step S335 (step S336). Specifically, the terminal CPU 91 stores the credit data of the payout for the roulette game in the RAM 93. And the terminal CPU 91 also stores the accumulated JP credits in the RAM 93 if the JP has been won. Then, when the payout button 5 is touched, the number of medals corresponding to the credits stored in the RAM 93 (usually, one medal per one credit) are paid from the medal payout opening 12. Thereafter, the terminal CPU 91 terminates the bet accepting processing.

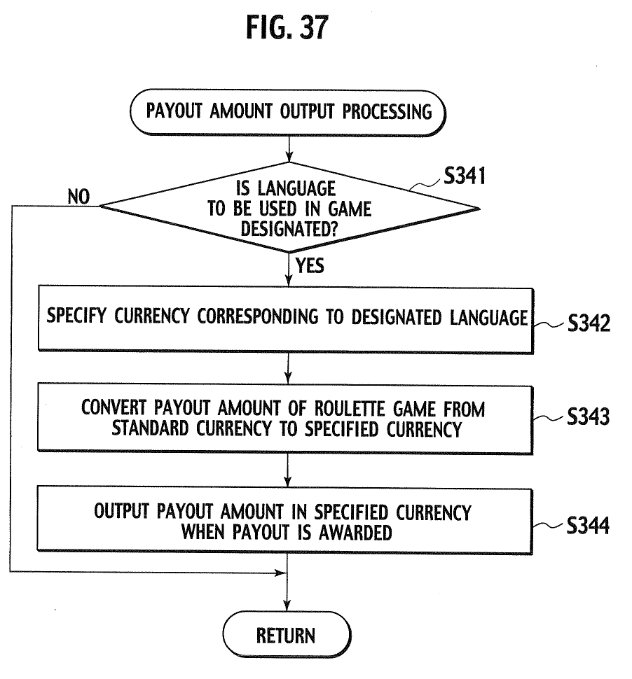

Next, in the payout amount output processing in step S303 shown in FIG. 33, the terminal CPU 91 judges whether or not the language type to be used for playing the game is designated in the massage (the response sentence) (step S341) as shown in FIG. 37, which is inputted in step S300c of the used language confirmation processing shown in FIG. 34. If the language type is not designated (NO in step S341), the terminal CPU 91 terminates the payout amount output processing. When the language type is designated (YES in step S341), the terminal CPU 91 specifies the currency type corresponding to the designated language type (step S342).

Here, the currency type corresponding to the designated language type can be specified by use of the currency data linking the multiple language types usable in the game with the currency types respectively corresponding to the language types, which are stored in the external memory 99 (see FIG. 8) of the gaming terminal 4.

Moreover, the terminal CPU 91 converts the payout amount in the standard currency in the roulette games that are repeatedly executed by the gaming terminal 4 into the amount in the currency type corresponding to the designated language type (the specified currency type) (step S343), which is specified in step S342.

Here, the payout amount in the standard currency can be converted into the amount in the currency type corresponding to the designated language type (the specified currency type) by using the rate data showing the conversion rates between the respective currency types in the currency data with the standard currency, which are stored in the external memory 99 (see FIG. 8).

Then, the terminal CPU 91 includes the converted payout amount in the specified currency type in a message (a conversation sentence) to be outputted when the payout is determined (step S344). Thereafter, the terminal CPU 91 terminates the payout amount output processing.

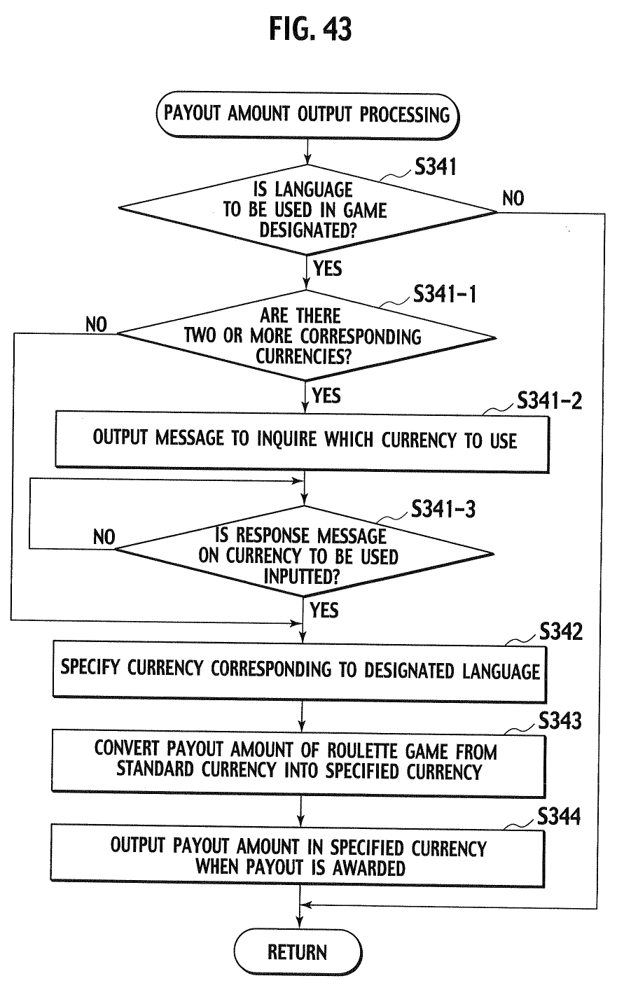

Here, the currency type corresponding to the language type designated in step S341 is not always one as in the case of English in the currency data shown in FIG. 38, for example. Accordingly, the contents of the payout amount output processing in step S303 in FIG. 33 may be changed as shown in a flowchart of FIG. 43.

Specifically, when the language to be used for the game is designated (YES in step S341), the terminal CPU 91 judges whether or not there are one or more currency types in the currency data in FIG. 38 which correspond to the designated language type (step S341-1). When there are not one or more currency types (NO in step S341-1), the terminal CPU 91 shifts the processing to step S342. When there are one or more currency types (YES in step S341-1), the terminal CPU 91 outputs a used currency type inquiry message (a conversation sentence) to inquire to the player which currency type to be used in the payout (step S341-2).

This message may be outputted in the sound from the speaker 10 through the sound input circuit 98 or outputted in the form of display of characters or the like on the display 8 through the LCD driving circuit 95.

For example, when outputting the message in the sound, the terminal CPU 91 outputs, by using the default language type, the sound for requesting selection of the currency type to be used in the payout from the speaker 10. When the default language type is English, for instance, the terminal CPU 91 outputs the sound stating “What kind of currency do you want to use for display?” from the speaker 10.

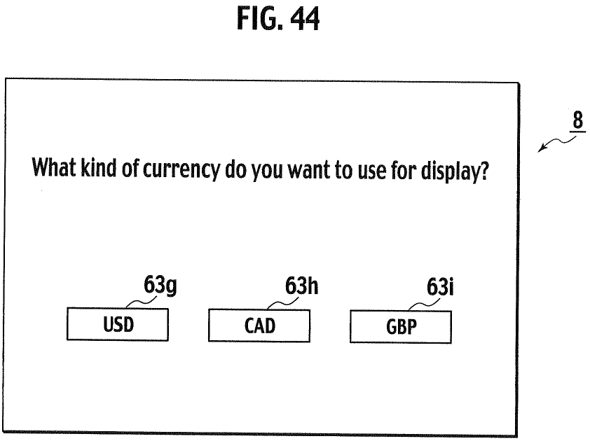

Meanwhile, when outputting the message in the form of display, the terminal CPU 91 displays, by using the default language type, characters, buttons, and the like on the display 8 in order to allow the player to select the currency type to be used when the payout is determined. For example, when the default language type is English, the terminal CPU 91 displays characters stating “What kind of currency do you want to use for display?” together with buttons 63g, 63h, and 63i representing currency options of “USD”, “CAD”, and “GBP” as shown in FIG. 44.

Then, the terminal CPU 91 confirms whether or not a response message (a response sentence) to the message outputted in step S341-2 is inputted (step S341-3).

Here, when the message outputted in step S341-2 is in the sound, the presence of the input of the message responding to the outputted message can be confirmed by checking whether or not there is an input into the input unit 1100, which can be formed of the microphone 15, of the conversation controller 1000 after the output of the message in step S341-2. On the other hand, when the message outputted in step S341-2 is in the form of display on the display 8, the presence of the input of the message responding to the outputted message can be confirmed by checking whether or not the touch panel 50 detects that the player operates any of the buttons 63g, 63h, and 63i shown in FIG. 44 stating “USD”, “CAD”, and “GBP” for currency selection displayed on the display 8.

Thereafter, if the response message to the message outputted in step S341-2 is not inputted (NO in step S341-3), the terminal CPU 91 repeats the processing in step S341-3 until the input. The terminal CPU 91 shifts the processing to step S342 when the response message is inputted (YES in step S341-3).

In step S342, the terminal CPU 91 specifies the currency type corresponding to the designated language.

Here, the currency type corresponding to the designated language in the case where there are not one or more currency types corresponding to the designated language (NO) in step S341-1 can be specified by use of the currency data stored in the external memory 99 (see FIG. 8) of the gaming terminal 4, which link the multiple language types usable in the game with the currency types that correspond to the respective language types.

On the other hand, the currency type corresponding to the designated language in the case where there are one or more currency types corresponding to the designated language (YES) in step S341-1 can be specified to the currency designated in the response message inputted in step S341-3.

Thereafter, concerning step S343 and step S344, the terminal CPU 91 execute similar processing to the used language confirmation processing as shown in FIG. 34.

Here, the message to be outputted when the payout is determined may be outputted in the sound from the speaker 10 through the sound input circuit 98 or outputted in the form of display of characters or the like on the display 8 through the LCD driving circuit 95.

For example, when outputting the message in the sound, the terminal CPU 91 outputs the sound from the speaker 10 by using the designated language. When the designated language type is English, for instance, the terminal CPU 91 outputs the sound stating “You win 10 dollars” from the speaker 10.

Meanwhile, when outputting the message in the form of display, the terminal CPU 91 displays characters, buttons and the like on the display 8 in order to allow the player to select the language to be used in the game by using the designated language type. For example, when the designated language type is English, the terminal CPU 91 displays characters stating “You win 10 dollars.” as shown in FIG. 41.

As apparent from the foregoing description, according to the roulette game device 1 of this embodiment, the terminal CPU 91 constitutes the inquiry timing detection unit, the change timing detection unit, and the controller of the present invention.

As described above, the gaming terminal 4 of the roulette game device 1 according to the embodiment of the present invention outputs the messages (the conversation sentences) in the forms of sounds and characters from the speaker 10 and the display 8 while sequentially changing the language types used therein either by use of the conversation controller 1000 compatible with the multiple language types or by use of the multiple conversation controllers 1000 respectively compatible with the language types.

In response to this output, the player inputs the message (the response sentence) in the sound by using the particular language type through the microphone 15 or inputs the message (the response sentence) in the form of the characters by operating the touch panel 50 on the display 8 within the certain time after the output of the message using the language type that the player wishes to use in the roulette game.

Then, the gaming terminal 4 outputs the message (the conversation sentence) for requesting the approval to apply the language type used in the response message as the language type to be used in the game from the speaker 10 and the display 8 in the forms of the sounds and the characters.

In response to this output, the player inputs the message (the response sentence) for the approval to apply the language type used in the response message as the language type to be used in the game either in the sound through the microphone 15 or in the form of the characters by operating the touch panel 50 on the display 8.

After inputting the message of the approval by the player in the form of the sound or the characters, the gaming terminal 4 exchanges the conversations in the forms of the sounds and the characters with the player by use of the language type approved by the player.

Accordingly, in the roulette game device 1 according to the embodiment of the present invention, the language type to be used in the roulette game is set to the language type corresponding to the request by the player by performing the conversations between the gaming terminal 4 and the player in the forms of the sounds and the characters. Thereafter, the information in the conversation mode is exchanged between the gaming terminal 4 and the player by use of the language type thus set up. As a result, it is possible to achieve interactive gaming.

Also, according to the roulette game machine 1 of the embodiment of the present invention, by analyzing the messages inputted in the form of the sounds and the characters with the conversation controller 1000, it is possible to read the history of the roulette games with the gaming terminal 4 in the past and the gaming history of the player in the past, which are the targets of requests for inquiries, out of the external memory 100 and the smart card 17, and to output, from the speaker 10 and the display 8 in the form of the sound and the characters, the messages (the conversation sentences) including the histories thus read out.

As a result, according to the gaming terminal 4 of the roulette game machine 1 of the embodiment of the present invention, it is possible to deliver the information requested by the player interactively from the gaming terminal 4 to the player. In this way, it is possible to execute interactive gaming.

Incidentally, the gaming terminal 4 may not have to include the configuration to read the history of the roulette games with the gaming terminal 4 in the past or the gaming history of the player in the past, which the player requests for inquiry by inputting the message in the sound or characters, from the external memory 100 or the smart card 17, and to output the messages (the conversation sentences) from the speaker 10 or the display 8 in the sound or characters.

Although the embodiments of the present invention have been described hereinabove, the embodiments are only showing specific examples, and do not particularly limit the present invention. Accordingly, the specific configuration of each means or the like can be modified in design appropriately. In addition, the effects described in the embodiments of the present invention are only listing the most preferable effects that can arise from the present invention. For this reason, the effects produced by the present invention are not limited to those described in the embodiments of the present invention.

For example, the foregoing embodiment has been described by taking the roulette game machine 1 as one example. However, the present invention is also applicable to other gaming machines for games such as a bingo game and a slot game, for example.

In addition, in the foregoing detail description, the characteristic portions of the present invention have been mainly described in order to make the present invention easily understandable. The present invention is not limited to the embodiments described above in the foregoing detail description, and can be applied to other embodiments, and its applicable range is wide. Moreover, the terms and the terminology used in the present specification are used for the purpose of precisely explaining the present invention, and not used for the purpose of limiting interpretations of the present invention. Further, it should be easy for those skilled in the art to contemplate other configurations, systems, methods, etc., which are included in the concept of the present invention, from the concept of the present invention described in the present specification. For this reason, the description of the appended claims must be construed as containing equivalent configurations within a range of not departing from a range of the technical ideas of the present invention. Moreover, the abstract aims to allow the Patent Office, general public office, and engineers who are not familiar with a patent, legal terms and technical terms, and who pertain to the technical field of the present invention, to quickly judge the technical content and essence of the present application with a simple study. Accordingly, the abstract is not intended to limit the scope of the invention that should be assessed from the description of the appended claims. Furthermore, it is desirable that the present invention be interpreted by fully taking already-disclosed literatures and the like into consideration in order to fully understand the object of the present invention and unique effects of the present invention.

The forgoing detail descriptions include the processing executed by the computer. The above descriptions and expressions are described in order for those skilled in the art to understand the present invention in the most efficiently. In this specification, each step used for deriving one result should be understood as a processing without a self-contradiction. Moreover, in each step, a transmission, reception, storage, etc., of an electric or magnetic signal is performed. A bit, value, symbol, letter, term, number and the like are used to express such signals in the processing in each step, but it should be noted that these are simply used to make the explanation easy. In addition, the processing at each step is sometimes described in an expression in common with human activities, but the processings described in this specification are principally executed by various types of devices. Furthermore, another configuration required for executing each step is obvious from the foregoing descriptions.

What is claimed is:

1. A gaming machine comprising:
an output unit configured to output a conversation sentence to a player;
an input unit configured to enable a player to input a response sentence to the conversation sentence outputted from the output unit;
a conversation engine configured to create data on the conversation sentence to be outputted from the output unit and configured to analyze data on the response sentence inputted into the input unit;
a currency memory configured to store currency data linking a plurality of language types usable for play on the gaming machine, with currency types respectively corresponding to the language types;
a rate memory configured to store rate data indicating conversion rates of the respective currency types to a standard currency in the currency data; and
a controller configured to
(a) cause the conversation engine to create data on the conversation sentence inquiring a language type to be used for play on the gaming machine,
(b) judge whether or not the language type to be used for play on the gaming machine is designated in the response sentence having the data analyzed by the conversation engine, and
(c) upon the language type to be used for play on the gaming machine being designated in the response sentence having the data analyzed by the conversation engine, cause the conversation engine to create data on a subsequent conversation sentence including information on a converted amount of an award generated during repeatedly executed unit games, the converted amount of the award being expressed in a certain one of the currency types linked with the designated language type in the currency data and being obtained by conversion from the standard currency at the conversion rate of the certain currency type.

2. The gaming machine according to claim 1, wherein the controller is configured to update the rate data in the rate memory with latest rate data every time the latest data are inputted from outside.

3. The gaming machine according to claim 1, further comprising:
a display configured to display an amount of credits digitized and accumulated in the gaming machine for making bets on the repeatedly executed unit games,
wherein, upon the certain one of the currency types linked with the designated language type in the currency data being different from the standard currency, the controller is configured to display a converted amount of the credits accumulated in the gaming machine in the certain currency type linked with the designated language type in the currency data, the converted amount being obtained by conversion from the standard currency at the conversion rate of the certain currency type.

4. A gaming machine comprising:
an output unit configured to display a conversation sentence to a player;
an input unit configured to enable a player to input a response sentence to the conversation sentence displayed on the output unit;
a conversation engine configured to create data on the conversation sentence to be displayed on the output unit and configured to analyze data on the response sentence inputted into the input unit;
a currency memory configured to store currency data linking a plurality of language types usable for play on the gaming machine, with currency types respectively corresponding to the language types;
a rate memory configured to store rate data indicating conversion rates of the respective currency types to a standard currency in the currency data; and
a controller configured to
(a) cause the conversation engine to create data on the conversation sentence inquiring the language type to be used for play on the gaming machine,
(b) judge whether or not the language type to be used for play on the gaming machine is designated in the response sentence having the data analyzed by the conversation engine, and
(c) upon the language type to be used for play on the gaming machine being designated in the response sentence having the data analyzed by the conversation engine, cause the conversation engine to create data on a subsequent conversation sentence including information on a converted amount of an award generated during repeatedly executed unit games, the converted amount of the award being expressed in a certain one of the currency types linked with the designated language type in the currency data and being obtained by conversion from the standard currency at the conversion rate of the certain currency type.

5. The gaming machine according to claim 4, wherein the controller is configured to update the rate data in the rate memory with latest rate data every time the latest data are inputted from outside.

6. The gaming machine according to claim 4, wherein, upon the certain one of the currency types linked with the designated language type in the currency data being different from the standard currency, the controller is configured to cause the conversation engine to create data on a conversation sentence including a converted amount of credits digitized and accumulated in the gaming machine for making bets on the unit games, the converted amount being expressed in the certain currency type linked with the language type designated in the currency data and being obtained by conversion from the standard currency at the conversion rate of the certain currency type.

7. A gaming machine comprising:
an output unit configured to output a conversation sentence to a player;
an input unit configured to enable a player to input a response sentence to the conversation sentence outputted from the output unit;
a conversation engine configured to create data on the conversation sentence to be outputted from the output unit and configured to analyze data on the response sentence inputted into the input unit;
a display configured to display repeatedly executed unit games together with an amount of an award in a standard currency generated in the unit games;
a currency memory configured to store currency data linking each of a plurality of language types usable for play on the gaming machine, with at least one currency type corresponding to the language type;
a rate memory configured to store rate data indicating conversion rates of the respective currency types to the standard currency in the currency data; and
a controller configured to
(a) cause the conversation engine to create data on the conversation sentence inquiring the language type to be used for play on the gaming machine,
(b) judge whether or not the language type to be used for play on the gaming machine is designated in the response sentence having the data analyzed by the conversation engine,
(c) upon the language type to be used for play on the gaming machine being designated in the response sentence having the data analyzed by the conversation engine, judge whether or not there are a plurality of currency types linked with the designated language type in the currency data,
(d) upon there being the plurality of currency types linked with the designated language type in the currency data, cause the conversation engine to create data on a conversation sentence inquiring selection of the currency type to be used for display of the award on the display, out of the plurality of currency types linked with the designated language type in the currency data,
(e) judge whether or not the currency type to be used for display of the award on the display is designated in a response sentence having the data analyzed by the conversion engine, and
(f) upon the currency type to be used for display of the award on the display being designated in the response sentence having the data analyzed by the conversion engine, display a converted amount of the award, the converted amount being obtained by conversion from the standard currency at the conversion rate of the designated currency type.

8. The gaming machine according to claim 7, wherein the controller is configured to update the rate data in the rate memory with latest rate data every time the latest data are inputted from outside.

9. The gaming machine according to claim 7, wherein, upon the currency type to be used for display of the award on the display being designated, the controller is configured to display a converted amount of credits digitized and accumulated in the gaming machine for making bets on the unit games, the converted amount being expressed in the designated currency type and being obtained by conversion from the standard currency at the conversion rate of the designated currency type.

10. A method of playing a gaming machine comprising:
(a) causing a conversation engine to create data on a conversation sentence inquiring of a player what language type to be used for play on the gaming machine,
(b) outputting the conversation sentence inquiring what language type to be used for play on the gaming machine by using the data created by the conversation engine;
(c) enabling the player to input, into an input unit, a response sentence designating the language type to be used for play on the gaming machine;
(d) causing the conversation engine to analyze data on the response sentence inputted into the input unit by the player;
(e) judging whether or not the language type to be used for play on the gaming machine is designated in the response sentence having the data analyzed by the conversation engine;
(f) upon the language type to be used for play on the gaming machine being designated in the response sentence having the data analyzed by the conversation engine, specifying a currency type linked with the designated language type in currency data stored in a currency memory, the currency data linking a plurality of language types usable for play on the gaming machine, with currency types respectively corresponding to the language types;
(g) converting an amount of an award generated in repeatedly executed unit games from a standard currency into the specified currency type by using one of the conversion rates of the respective currency types to the standard currency in the currency data, the conversion rates being indicated by rate data stored in a rate memory;
(h) causing the conversation engine to create data on a conversation sentence including information on the converted amount of the award in the specified currency type; and
(i) outputting, from the output unit, the conversation sentence including the information on the converted amount of the award in the specified currency type by using the data created by the conversation engine every time of generation of the award.

11. The method of playing a gaming machine according to claim 10, wherein each of the steps of (b) and (j) includes:
displaying the conversation sentence on the output unit.

12. The method of playing a gaming machine according to claim 10, further comprising:
(j) updating the rate data in the rate memory with latest rate data every time the latest data are inputted from outside.

13. The method of playing a gaming machine according to claim 10, further comprising:
(j) converting an amount of credits digitized and accumulated in the gaming machine for making bets on the repeatedly executed unit games, from the standard currency into the specified currency type by using the conversion rate; and
(k) displaying the converted amount of the credits in the specified currency type on a display.

14. A method of playing a gaming machine comprising:
(a) causing a conversation engine to create data on a conversation sentence inquiring of a player what language type to be used for play on the gaming machine,
(b) outputting the conversation sentence inquiring what language type to be used for play on the gaming machine by using the data created by the conversation engine;
(c) enabling the player to input, into an input unit, a response sentence designating the language type to be used for play on the gaming machine;
(d) causing the conversation engine to analyze data on the response sentence inputted into the input unit by the player;
(e) judging whether or not the language type to be used for play on the gaming machine is designated in the response sentence having the data analyzed by the conversation engine;
(f) upon the language type to be used for play on the gaming machine being designated in the response sentence having the data analyzed by the conversation engine, judging whether or not there are a plurality of currency types linked with the designated language type in currency data stored in a currency memory, the currency data linking each of a plurality of language types usable for play on the gaming machine, with at least one currency type corresponding to the language type;
(g) upon there being the plurality of currency types linked with the designated language type in the currency data, causing the conversation engine to create data on a conversation sentence inquiring selection of the currency type to be used for display of the award on the display out of the plurality of currency types linked with the designated language type in the currency data;
(h) judging whether or not the currency type to be used for display of the award on the display is designated in a response sentence having the data analyzed by the conversion engine; and
(i) upon the currency type to be used for display of the award on the display being designated in the response sentence having the data analyzed by the conversion engine, displaying a converted amount of the award in the designated currency type on the display, the converted amount of the award being obtained by conversion from the standard currency at a conversion rate of the designated currency type to the standard currency indicated by rate data stored in a rate memory.

15. The method of playing a gaming machine according to claim 14, further comprising:
(j) updating the rate data in the rate memory with latest rate data every time the latest data are inputted from outside.

16. The method of playing a gaming machine according to claim 14, further comprising:
(j) upon there being the plurality of currency types linked with the designated language type in the currency data, converting an amount of credits digitized and accumulated in the gaming machine for making bets on the repeatedly executed unit games, from the standard currency to the designated currency type by using the conversion rate; and
(k) displaying the converted amount of the credits in the designated currency type on the display.
